(19) United States
(12) Patent Application Publication
(10) Pub. No.: US 2026/0332197 A1
(43) Pub. Date: Oct. 22, 2026

(54) COMPACT AND FLEXIBLE 8 TX NON-COHERENT UL CODEBOOKS

(71) Applicant: Telefonaktiebolaget LM Ericsson (publ), Stockholm (SE)

(72) Inventors: Chandan Pradhan, Yokohama, Kanagawa (JP); Robert Mark Harrison, Grapevine, TX (US); Sven Jacobsson, Västra Frölunda (SE)

(21) Appl. No.: 19/481,473

(22) PCT Filed: May 9, 2024
(86) PCT No.: PCT/IB2024/054530

§ 371 Date: Nov. 4, 2025

Related U.S. Application Data
(60) Provisional application No. 63/501,904, filed on May 12, 2023.

(51) Int. Cl. H04B 7/0456; H04B 7/0404

(52) U.S. Cl. CPC H04B 7/0456; H04B 7/0404

(57) ABSTRACT

Systems and methods related to configuration and use of an eight transmit antenna port non-coherent (NC) codebook are disclosed. In one embodiment, a method performed by a User Equipment (UE) comprises transmitting N layers on one or more antenna port subsets of a set of eight antenna ports according to at least one of a set of NC precoders for N layers, wherein 2<N≤8, each subset comprises two antenna ports, and each antenna port is present in only one subset. In addition, for each precoder in the set, there is at most one antenna port subset with one active antenna port and all remaining subsets have either no active antenna ports or two active antenna ports; for each precoder in the set, each antenna port is active on at most one layer; and/or for each layer across the set of NC precoders, no more than four antenna ports are active.

### RELATED APPLICATIONS

This application claims the benefit of provisional patent application Ser. No. 63/501,904, filed May 12, 2023, the disclosure of which is hereby incorporated herein by reference in its entirety.

### TECHNICAL FIELD

The present disclosure relates to non-coherent transmission in a wireless network.

### BACKGROUND

In the time domain, 3^{rd} Generation Partnership Project (3GPP) New Radio (NR) downlink (DL) and uplink (UL) transmissions are organized into equally sized subframes of 1 millisecond (ms) each. A subframe is further divided into multiple slots of equal duration. The slot length depends on subcarrier spacing. For 15 kilohertz (kHz) subcarrier spacing, there is only one slot per subframe. In general, for 15·2^{∥} kHz subcarrier spacing, where μ∈{0,1,2,3,4}, there are 2^{μ} slots per subframe. Finally, each slot consists of 14 symbols (unless extended cyclic prefix is configured).

In the frequency domain, a system bandwidth is divided into Resource Blocks (RBs) each corresponding to 12 contiguous subcarriers. One subcarrier during one symbol interval forms one Resource Element (RE).

### 1 SRS

In NR, Sounding Reference Signal (SRS) is used for providing Channel State Information (CSI) to the next generation NodeB (gNB) in the UL. The usage of SRS includes, e.g., deriving the appropriate transmission/reception beams and/or to perform link adaptation (i.e., setting the transmission rank and the Modulation and Coding Scheme (MCS)), and for selecting DL (e.g., for Physical Downlink Shared Channel (PDSCH) transmissions) and UL (e.g., for Physical Uplink Shared Channel (PUSCH) transmissions) Multiple-Input Multiple-Output (MIMO) precoding.

In Long Term Evolution (LTE) and NR, the SRS is configured via Radio Resource Control (RRC), where parts of the configuration can be updated (for reduced latency) through Medium Access Control (MAC)-Control Element (CE) signaling. The configuration includes, for example, the SRS resource allocation (the physical mapping and the sequence to use) as well as the time-domain behavior (aperiodic, semi-persistent, or periodic). For aperiodic SRS transmission, the RRC configuration does not activate an SRS transmission from the User Equipment (UE) but instead a dynamic activation trigger is transmitted from the gNB in the DL, via the Downlink Control Information (DCI) in the Physical Downlink Control Channel (PDCCH) which instructs the UE to transmit the SRS once, at a predetermined time.

When configuring SRS transmissions, the gNB configures, through the SRS-Config Information Element (IE) defined in 3GPP Technical Specification (TS) 38.331 version 16.1.0, a set of SRS resources and a set of SRS resource sets, where each SRS resource set contains one or more SRS resources.

### 2 UL Transmission/Precoding Schemes

The physical channel that carries data in the NR UL, and to which the UE may apply precoding, is called the Physical Uplink Shared Channel (PUSCH). In NR, there are two possible waveforms that can be used for PUSCH: Cyclic Prefix OFDM (CP-OFDM) and Discrete Fourier Spread OFDM (DFT-S-OFDM). Also, there are two transmission schemes specified for PUSCH: CB-based precoding and NCB-based precoding.

The gNB configures, in RRC, the transmission scheme through the higher-layer parameter txConfig in the PUSCH-Config IE. CB-based transmission can be used for non-calibrated UEs and/or for Frequency Division Duplexing (FDD) (i.e., UL/DL reciprocity does not need to hold). NCB-based transmission, on the other hand, relies on UL/DL reciprocity and is, hence, intended for Time Division Duplexing (TDD).

### 2.1 CB-Based Precoding

CB-based PUSCH is enabled if the higher-layer parameter txConfig is set to ‘codebook’. For dynamically scheduled PUSCH with configured grant type 2, CB-based PUSCH transmission can be summarized in the following steps:
1. The UE transmits SRS, configured in an SRS resource set with higher-layer parameter usage in SRS-Config IE set to ‘codebook’. Up to two SRS resources (for testing up to two virtualizations/beams/panels) each with up to four ports, can be configured in the SRS resource set.
2. The gNB determines the number of layers (or rank) and a preferred precoder (i.e., Transmit Precoding Matrix Index (TPMI)) from a codebook subset based on the received SRS from one of the SRS resources. The codebook subset is configured via the higher-layer parameter codebookSubset, based on reported UE capability, and is one of:
   fully coherent (‘fully AndPartialAndNonCoherent’), or
   partially coherent (‘partialAndNonCoherent’), or
   non-coherent (‘nonCoherent’),
3. If two SRS resources are configured in the SRS resource set, the gNB indicates the selected SRS resource via a 1-bit SRS Resource Indicator (SRI) field in the DCI scheduling the PUSCH transmission. If only one SRS resource is configured in the SRS resource set, the SRI field is not indicated in DCI.
4. The gNB indicates, via DCI, the number of layers and the TPMI. Demodulation Reference Signal (DM-RS) port(s) associated with the layer(s) are also indicated in DCI. The number of bits in DCI used for indicating the number of layers (if transform precoding is enabled, the number of PUSCH layers is limited to 1) and the TPMI is determined as follows (unless UL full-power transmission is configured, for which the number of bits may be different):
   4, 5, or 6 bits if the number of antenna ports is 4, if transform precoding is disabled, and if the higher-layer parameter maxRank in PUSCH-Config IE is set to 2, 3, or 4 (see Table 7.3.1.1.2-2 of 3GPP TS 38.212 rev. 16.12.0).
   2, 4, or 5 bits if the number of antenna ports is 4, if transform precoding is disabled or enabled, and if the higher-layer parameter maxRank in PUSCH-Config IE is set to 1 (see Table 7.3.1.1.2-3 of 3GPP TS 38.212 rev. 16.12.0).
   2 or 4 bits if the number of antenna ports is 2, if transform precoding is disabled, and if the higher-layer parameter maxRank in PUSCH-Config IE is set to 2 (see Table 7.3.1.1.2-4 of 3GPP TS 38.212 rev. 16.12.0).
   1 or 3 bits if the number of antenna ports is 2, if transform precoding is disabled or enabled, and if the higher-layer parameter maxRank in PUSCH-Config IE is set to 1 (see Table 7.3.1.1.2-5 of 3GPP TS 38.212 rev. 16.12.0).
   0 bits if 1 antenna port is used for PUSCH transmission.
5. The UE performs PUSCH transmission over the antenna ports corresponding to the SRS ports in the indicated SRS resource.

For a given number of layers, the TPMI field indicates a precoding matrix that UE should use for PUSCH. In a first example, if the number of antenna ports is 4, the number of layers is 1, and transform precoding is disabled, then the set of possible precoding matrices is shown in Table 1. In a second example, if the number of antenna ports is 4, the number of layers is 4, and transform precoding is disabled, then the set of possible precoding matrices is shown in Table 2.

TABLE 1
Precoding matrix, W, for single-layer transmission using four antenna ports
when transform precoding is disabled (reproduced from
Table 6.3.1.5-3 of 3GPP TS 38.211 rev 16.10.0).

| TPMI index | (ordered from left to right in increasing order of TPMI index) | | | | | | | |
|---|---|---|---|---|---|---|---|---|
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}\begin{matrix}\begin{matrix}1 \\ 1\end{matrix} \\ - j\end{matrix} \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}\begin{matrix}\begin{matrix}1 \\ j\end{matrix} \\ - 1\end{matrix} \\ - j\end{matrix} ]$ | $\frac{1}{2} [ \begin{matrix}\begin{matrix}\begin{matrix}1 \\ j\end{matrix} \\ - j\end{matrix} \\ 1\end{matrix} ]$ | $\frac{1}{2} [ \begin{matrix}\begin{matrix}\begin{matrix}1 \\ - 1\end{matrix} \\ 1\end{matrix} \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}\begin{matrix}\begin{matrix}1 \\ - j\end{matrix} \\ - j\end{matrix} \\ - 1\end{matrix} ]$ | — | — | — | — |

TABLE 2
Precoding matrix, W, for four-layer transmission using four antenna ports
when transform precoding is disabled (reproduced from
Table 6.3.1.5-7 of 3GPP TS 38.211 rev 16.10.0).

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

How fully-, partially-, and non-coherent coherent transmission is facilitated in Rel-15 codebook-based transmission can be understood through the example precoding matrices above. Each column of a matrix contains a set of scale factors to be used to transmit a MIMO layer, and each row of a given column contains the scale factor to be applied to a particular antenna port for that layer. If a given scale factor is zero, then the UE should not transmit the MIMO layer on the antenna port. On the other hand, if at least two scale factors in a column are non-zero, they will combine together for a given layer, and the UE must transmit with mutually controlled phase among these antenna ports. If each column of a precoding matrix contains only one non-zero scale factor, the UE may transmit non-coherently, i.e., without mutually controlled phase. Examples of such non-coherent precoding matrices are those with TPMI indices 0-3 in Table 1 and with TPMI index 0 in Table 2. By contrast, if each column of a precoding matrix contains only non-zero scale factors, the UE must transmit with mutually controlled phase on all antenna ports, and so uses fully coherent transmission. Examples of fully-coherent precoding matrices include with TPMI indices 12-27 in Table 1 and TPMI indices 3 and 4 in Table 2. Finally, if each column of a precoding matrix contains some non-zero and some zero scale factors, the UE may transmit partially-coherently, with mutually controlled phase required only among subsets of the antenna ports. Examples of partial-coherent precoding matrices include with TPMI indices 4-11 in Table 1 and TPMI indices 1 and 2 in Table 2. It is important to also observe here that partial-coherent precoding is not possible for 2 transmit (Tx) operation, since with two port transmission either all or none of the ports are transmitted together in a coherent way. This need to consider partial-coherent operation complicates the design of 4 Tx UL MIMO schemes.

UEs that can maintain phase among antenna ports can generally transmit also without controlled phase. The converse where UEs that can transmit without controlled phase can be assumed to be able to also transmit with control phase is generally not true. Since transmitting without controlled phase is enabled through the use of zero-valued scale factors in Rel-15 non-coherent or partially-coherent precoding matrices, these precoders may be used to select which antenna ports to transmit upon. When the antennas corresponding to the antenna ports are directive, such selection can pick directions that the UE should transmit, and so these precoders can have better performance in some channel conditions than the fully coherent precoders (provided sufficient power is available for the antennas). Furthermore, transmitting on a subset of antenna ports can allow the UE to transmit with reduced total power. These two behaviors then can motivate the codebook designs described above, where precoding matrices with different coherence requirements are included in a codebook. Fully coherent UEs can support all three types of precoders, and can codebook labeled so support subsets as ‘fullyAndPartialAndNonCoherent’, while partially-coherent UEs can support non-coherent but not fully-coherent precoders, and so can support ‘partialAndNonCoherent’ codebook subsets. Lastly, non-coherent UEs only support the ‘nonCoherent’ precoders and codebook subset. This combination of precoders with different coherence types in a codebook or codebook subset may be referred to as ‘nesting’ the precoders.

The structure of non-coherent precoders in the Rel-15 design targets maximum performance. One precoder is defined for each possible combination of ports for a given number of layers with non-coherent operation. For example, in Table 3 below for two layer transmission with 4 ports, it can be seen that TPMI indices 0 to 5 include all 6 combinations for 2 out of 4 ports. Similarly, the 4 possible port combinations when one out of 4 ports are defined in TPMIs 0-3 for the single layer case as can be seen in Table 1 above. Moreover, it can be observed that each layer can be carried on 3 of the 4 antenna ports in the two layer case and all 4 of the antenna ports in the 1 layer case. This use of all possible combinations and occupancy of more than half of the antenna ports for non-coherent 1 and 2 layer transmission provides the best possible set of selections and therefore maximizes the performance of the non-coherent codebook by maximizing the diversity gain. By contrast, considering the 3 layer codebook with 4 ports in Table 4, there is a single non-coherent precoder defined: TPMI 0. In this case, fewer than all ports are transmitted on by the non-coherent precoder, since port 3 is not used. A rationale for using fewer than all port combinations for rank 3, but not ranks 2 or 1, is that there is less selection diversity gain with an increased number of ports or layers when non-coherent transmission is used.

TABLE 3
Precoding matrix W for two-layer transmission using four antenna ports with
transform precoding disabled (reproduced from
Table 6.3.1.5-5 of 3GPP TS 38.211 rev 16.10.0).
W

| TPMI index | (ordered from left to right in increasing order of TPMI index) | | | |
|---|---|---|---|---|
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ |
| 16-19 | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ 1 & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |
| 20-21 | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ | — | — |

TABLE 4
Precoding matrix W for three-layer transmission using four antenna ports with
transform precoding disabled (reproduced from
Table 6.3.1.5-6 of 3GPP TS 38.211 rev 16.10.0).

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ |
| 4-6 | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ | — |

Considering the partially coherent precoders in TPMI indices 6-13 in
it can be observed that, for all these precoders, the first layer (corresponding to the elements in the first column of each precoder) is transmitted on ports 0 and 2, while the second layer (the elements in the second column) is transmitted on ports 1 and 3. This design supports where only ports 0 and 2 or ports 1 and 3 are mutually coherent; if a layer were transmitted with ports 1 and 2 for example, then this would require coherence among ports 0, 1, and 2, which is not consistent with the notion of partial coherence where only pairs of Tx chains are coherent in a partially coherent UE. Examining Table 4 for 3 layer transmission, the same constraint applies. Partially coherent TPMIs 1 and 2 use ports 0 and 2 for the first layer, and ports 1 and 3 for the second and third layers, respectively.

### 3 Discussions in Rel-18 Related to 8 Tx UE

In 3GPP Rel-18, the following agreements were made. It may be observed that the UE antenna layouts agreed below for the Rel-18 8 Tx UL MIMO codebook design work include arrays of cross-polarized (‘xpol’) elements with two polarizations collocated in an element, as well as arrays of single polarized elements.

### *****Start Agreements*****

### Agreement

For 8TX UE, consider the following UE antenna layouts for codebook design,
For non-coherent UEs, consider linear array (1D/2D) of cross-polarized or single-polarized antenna configuration
For fully/partial-coherent UEs, consider linear array (1D/2D)
   Where the array is either cross-polarized antenna configuration or single polarized antenna configuration
   N_{g}>=1 antenna groups can be considered where each group comprises coherent antennas, and across groups, antennas can be non-coherent/coherent depending on device types
      An example of an antenna group is a panel
   Within an antenna group, antenna elements are uniformly spaced. Across different antenna groups, companies to provide details.
      Additional information for definition of antenna layout
Based on the number of coherent groups, following exemplary cases can be considered where, within each group, antenna elements are spaced by 0.5λ, and then d_{G-H}, d_{G-V} represent the horizontal and vertical spacings between the centers of adjacent antenna groups, respectively
   Further down-selection can be done in the next meeting, if needed
   The shown exemplary placing of antenna groups can be used for evaluation purpose, but the codebook design is not restricted to shown cases.
   Other antenna layouts for other use cases are not precluded.
   To start companies may report their results according to their preferred layout.

| | | (M, N, P) per | | | Antenna Pattern/Antenna |
|---|---|---|---|---|---|
| Case | Ng | group | Antenna Layout | | Element Gain |
| 1 | 1 | (2, 2, 2), (1, 4, 2) | 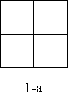 | 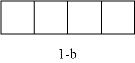 | Isotropic (Indoor/Outdoor FWA & Industrial) 8 dBi, 65° HPBW(Outdoor FWA) |
| 2 | 2 | (1, 2, 2) | 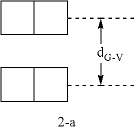 | 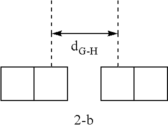 | Isotropic (Indoor/Outdoor FWA & Industrial) 8 dBi, 65° HPBW(Outdoor FWA) |

| | | | | |
|---|---|---|---|---|
| 3 | 4 | (1, 1, 2) | 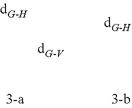 | Isotropic (Indoor/Outdoor FWA & Industrial) 4 dBi, 110° HPBW(Indoor FWA & Industrial |

### Agreement

For partially coherent uplink precoding by an 8TX UE codebook,
When N_{g}=2
   Precoding design is based on Rel-15 UL 4TX codebook,
      Full-coherent precoders are used
         FFS whether partial-coherent precoders are needed
When N_{g}=4, down-select from,
   Alt1:
      Precoding design is based on Rel-15 UL 2TX codebook,
         Full-coherent precoders are used
   Alt2:
      Precoding design is based on Rel-15 UL 4TX codebook,
         Partial-coherent precoders are used

### Agreement

### For Non-Coherent Uplink Precoding by an 8TX UE, Following Precoders are Supported for 1 Layer Transmission.

$$[ \begin{matrix}1 \\ 0 \\ 0 \\ 0 \\ 0 \\ 0 \\ 0 \\ 0\end{matrix} ] , [ \begin{matrix}0 \\ 1 \\ 0 \\ 0 \\ 0 \\ 0 \\ 0 \\ 0\end{matrix} ] , [ \begin{matrix}0 \\ 0 \\ 1 \\ 0 \\ 0 \\ 0 \\ 0 \\ 0\end{matrix} ] , [ \begin{matrix}0 \\ 0 \\ 0 \\ 1 \\ 0 \\ 0 \\ 0 \\ 0\end{matrix} ] , [ \begin{matrix}0 \\ 0 \\ 0 \\ 0 \\ 1 \\ 0 \\ 0 \\ 0\end{matrix} ] , [ \begin{matrix}0 \\ 0 \\ 0 \\ 0 \\ 0 \\ 1 \\ 0 \\ 0\end{matrix} ] , [ \begin{matrix}0 \\ 0 \\ 0 \\ 0 \\ 0 \\ 0 \\ 1 \\ 0\end{matrix} ] , [ \begin{matrix}0 \\ 0 \\ 0 \\ 0 \\ 0 \\ 0 \\ 0 \\ 1\end{matrix} ]$$

with the scaling factor of

$$\frac{1}{2 \sqrt{2}} .$$

### *****End Agreements*****

Accordingly, as part of the agreements for codebook-based transmission for 8 Tx, it has been agreed that the UE can transmit with non-coherent precoders if there are no controlled phase between the 8 antenna ports. Further, two types of partially-coherent UEs will be supported, one with 2 antenna groups (with 4 antenna ports per antenna group), and one with four antenna groups (with two antennas ports per antenna group). It has also been agreed that the antennas within one antenna group are assumed to be mutually coherent, and antenna ports belonging to different antenna groups are assumed not to be mutually coherent. Though the non-coherent precoders is agreed for rank 1, the non-coherent precoders for rank >1 still need to be agreed.

A proposal for a non-coherent codebook with a reduced number of precoders was discussed in RAN1 #112bis-e in R1-2302309 as follows. From the figure (reproduced herein as FIG. 1), it can be seen that the design assumes a uniform linear array of cross-polarized elements, where both polarizations of an element are used before using another element, and adjacent elements are used first.
Updated Proposal 3.5: For non-coherent uplink precoding with rank≤8 by an 8TX UE,
   Alt1.—All 255 combinations of non-coherent rankl precoders are supported
   Alt2.—Only a subset of Alt1. is supported
      Example (ZTE, Samsung): For the shown antenna set up, NC precoders can be defined as follows,

### See FIG. 1

### SUMMARY

Systems and methods related to compact and flexible eight (8) transmit antenna port non-coherent codebook design and configuration and associated transmission are disclosed. In one embodiment, a method performed by a UE for NC multi-antenna transmission comprises transmitting N layers on one or more antenna port subsets from a plurality of antenna port subsets of a set of eight antenna ports according to at least one precoder of a set of NC precoders for N layers, wherein N is at least two and is no more than eight, each antenna port subset of the plurality of antenna port subsets comprises two antenna ports from the set of eight antenna ports, and each antenna port of the set of eight antenna ports is present in only one of the plurality of antenna port subsets. In addition, for each precoder in the set of NC precoders for N layers, there is at most one of the plurality of antenna port subsets with one active antenna port for the precoder and all remaining antenna port subsets of the plurality of antenna port subsets have either no active antenna ports for the precoder or two active antenna ports for the precoder; and/or for each precoder in the set of NC precoders for N layers, each antenna port of the set of eight antenna ports is active on at most one layer for the precoder; and/or for each layer of the N layers across the set of NC precoders for N layers, no more than four of the set of eight antenna ports are active for the layer across the set of precoders for N layers. In this manner, the codebook is such that related signaling overhead is limited while having negligible loss in performance as compared to using prior solutions.

Corresponding embodiments of a UE are also disclosed. In one embodiment, a UE for NC multi-antenna transmission is adapted to transmit N layers on one or more antenna port subsets from a plurality of antenna port subsets of a set of eight antenna ports according to at least one precoder of a set of NC precoders for N layers, wherein N is at least two and is no more than eight, each antenna port subset of the plurality of antenna port subsets comprises two antenna ports from the set of eight antenna ports, and each antenna port of the set of eight antenna ports is present in only one of the plurality of antenna port subsets. In addition, for each precoder in the set of NC precoders for N layers, there is at most one of the plurality of antenna port subsets with one active antenna port for the precoder and all remaining antenna port subsets of the plurality of antenna port subsets have either no active antenna ports for the precoder or two active antenna ports for the precoder; and/or for each precoder in the set of NC precoders for N layers, each antenna port of the set of eight antenna ports is active on at most one layer for the precoder; and/or for each layer of the N layers across the set of NC precoders for N layers, no more than four of the set of eight antenna ports are active for the layer across the set of precoders for N layers.

Embodiments of a method performed by a network node are also disclosed. In one embodiment, a method performed by a network node comprises transmitting to a UE an indication of a precoder to be used by the UE for transmission, the precoder being indicated from among codebook comprising a set of NC precoders for non-coherent multi-antenna transmission using N layers on one or more antenna port subsets of a plurality of antenna port subsets of a set of eight antenna ports, wherein N is at least two and is no more than eight, each antenna port subset of the plurality of antenna port subsets comprises two antenna ports from the set of eight antenna ports, and each antenna port of the set of eight antenna ports is present in only one of the plurality of antenna port subsets. In addition, for each precoder in the set of NC precoders for N layers, there is at most one of the plurality of antenna port subsets with one active antenna port for the precoder and all remaining antenna port subsets of the plurality of antenna port subsets have either no active antenna ports for the precoder or two active antenna ports for the precoder; and/or for each precoder in the set of NC precoders for N layers, each antenna port of the set of eight antenna ports is active on at most one layer for the precoder; and/or for each layer of the N layers across the set of NC precoders for N layers, no more than four of the set of eight antenna ports are active for the layer across the set of precoders for N layers.

In one embodiment, a network node comprises processing circuitry configured to cause the network node to transmit to a UE an indication of a precoder to be used by the UE for transmission, the precoder being indicated from among codebook comprising a set of NC precoders for non-coherent multi-antenna transmission using N layers on one or more antenna port subsets of a plurality of antenna port subsets of a set of eight antenna ports, wherein N is at least two and is no more than eight, each antenna port subset of the plurality of antenna port subsets comprises two antenna ports from the set of eight antenna ports, and each antenna port of the set of eight antenna ports is present in only one of the plurality of antenna port subsets. In addition, for each precoder in the set of NC precoders for N layers, there is at most one of the plurality of antenna port subsets with one active antenna port for the precoder and all remaining antenna port subsets of the plurality of antenna port subsets have either no active antenna ports for the precoder or two active antenna ports for the precoder; and/or for each precoder in the set of NC precoders for N layers, each antenna port of the set of eight antenna ports is active on at most one layer for the precoder; and/or for each layer of the N layers across the set of NC precoders for N layers, no more than four of the set of eight antenna ports are active for the layer across the set of precoders for N layers.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an example of NC precoders for a shown antenna set-up;

FIG. 2 illustrates port numbering for 8 Tx antennas, where port number {0,1,2,3} and {4,5,6,7} belong to different polarizations, with ports {0,4}, {1,5}, {2,6} and {3,7} forming dual polarized antenna ports. Further, the 8 Tx antenna ports are divided onto N_{g}∈{1,2,4} antenna groups. Note that for N_{g}=1, the 8 Tx ports can be arranged in a uniform linear array (ULA), as in the figure, or a uniform planar array (UPA);

FIG. 3 illustrates transmission for two layers, where the port 2 is transmitted on one layer from the first polarization and the port 6 is transmitted on one layer from the second polarization;

FIG. 4 illustrates transmission for three layers, where port numbers {0, 2} are transmitted on one layer each from the first polarization and port 4 is transmitted on one layer from the second polarization;

FIG. 5 illustrates transmission for three layers with N_{g}=4, where port numbers {0, 3} are transmitted on one layer each from the first polarization and port 4 is transmitted on one layer from the second polarization, such that only group 1 and 4 are active;

FIG. 6 illustrates transmission for five layers, where ports {0, 1, 3} are transmitted on one layer each from the first polarization and ports {4,5} are transmitted on one layer each from the second polarization;

FIG. 7 illustrates transmission for three layers, where the 8 Tx antenna ports are grouped into four antenna groups such that ports {0,4}, {1,5}, {2,6} and {3,7} belong to different groups. The layers are transmitted from port number {0, 4} and {2} such that only 1^{st} and 3^{rd} antenna groups are active;

FIG. 8 illustrates transmission for three layers, where the 8 Tx antenna ports are grouped into four antenna groups such that ports {0,4}, {1,5}, {2,6} and {3,7} belong to different groups. The layers are transmitted from port number {1, 5} and {3} such that only 2^{nd} and 4^{th} antenna groups are active;

FIG. 9 illustrates transmission for three layers, where the 8 Tx antenna ports are grouped into two antenna groups such that ports {0,1,4,5} and {2,3,6,7} belong to different groups. The layers are transmitted from port number {2,6} and {3} such that only 2^{nd} antenna group is active;

FIG. 10 illustrates transmission for three layers, where the 8 Tx antenna ports are grouped into four antenna groups such that ports {0,4}, {1,5}, {2,6} and {3,7} belong to different groups. The layers are transmitted from port number {0, 4} and {3} such that only 1^{st} and 4^{th} antenna groups are active;

FIG. 11 illustrates transmission for three layers, where the 8 Tx antenna ports are grouped into four antenna groups such that ports {0,4}, {1,5}, {2,6} and {3,7} belong to different groups. The layers are transmitted from port number {1, 5} and {2} such that only 2^{nd} and 3^{rd} antenna groups are active;

FIG. 12 illustrates transmission for three layers, where the 8 Tx antenna ports are grouped into two antenna groups such that ports {0,1,4,5} and {2,3,6,7} belong to different groups. The layers are transmitted from port number {0, 4} and {1} such that only 1^{st} antenna group is active;

FIG. 13 shows the performance of the NC designs for an indoor UMi scenario, where all the UE are deployed indoor resulting in a low SINR transmission;

FIG. 14 shows the performance for the same setup as in FIG. 13 but for an outdoor UMa scenario, where all the UEs are deployed outdoor resulting in high SINR transmission;

FIG. 15 is a flow chart that illustrates the operation of a UE in accordance with at least some embodiments of the present disclosure;

FIG. 16 is a flow chart that illustrates the operation of a network node in accordance with at least some embodiments of the present disclosure;

FIG. 17 shows an example of a communication system in accordance with some embodiments of the present disclosure;

FIG. 18 shows a User Equipment device (UE) in accordance with some embodiments of the present disclosure;

FIG. 19 shows a network node in accordance with some embodiments of the present disclosure; and

FIG. 20 is a block diagram illustrating a virtualization environment in which functions implemented by some embodiments of the present disclosure may be virtualized.

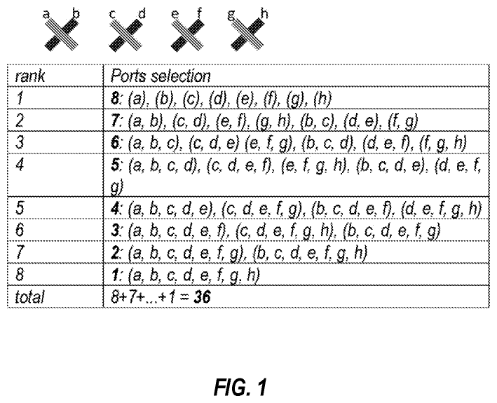

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Embodiments are provided by way of example to convey the scope of the subject matter to those skilled in the art.

There currently exist certain challenge(s). For eight (8) Transmitter (Tx) codebook transmission, Non-Coherent (NC) codebooks can be designed by selecting all the precoder matrices obtained by choosing r ports out of 8 ports, where r is the transmission rank. This will result in 255 candidates for maximum rank of 8, requiring 8 bits of Downlink Control Information (DCI) signaling overhead. Non-coherent codebooks based on 3GPP Rel-15 principles of using all possible port combinations and occupying more than half of the antenna ports will have a lesser, but still substantial overhead.

Moreover, it has been discussed that the NC precoders can be nested with Fully-Coherent (FC) or Partially-Coherent (PC) precoders to save power by transmitting on a smaller subset of Tx chains deployed at the UE. However, nesting all NC precoders with FC and PC precoders can further increase the signaling overhead (see, e.g., R1-2303660 “SRI/TPMI Enhancements for Enabling 8 TX UL Transmission”, April 2023). This calls for design of a smaller number of the NC precoders, which can decrease the DCI signaling overhead with a minimal loss in performance.

Certain aspects of the disclosure and their embodiments may provide solutions to these or other challenges. For 8 Tx codebook transmission, the maximum number of NC precoders is 255, which can consume 8 bits for DCI signaling overhead, which also increases the scheduling overhead for the network. Accordingly, systems and methods are disclosed herein that provide a reduced number of NC precoders which decreases the DCI signaling overhead without much loss in performance. Further, the reduced NC precoders can be nested with FC and PC precoders to allow the UE to transmit on a smaller subset of antenna ports to save power. Embodiments related to signaling for nested NC precoders with FC or PC precoders are also disclosed.

Some example embodiments of the present disclosure are as follows:

### Example Embodiment 1

In this example embodiment, NC precoders maximize cross-polarized (‘xpol’) ports per group. For each precoder, each port in an xpol pair is transmitted for all xpol pairs for an even number of layers, and all but one xpol pair for an odd number of layers, where each port in an xpol pair is on a different layer. A given layer in each precoder of the set of precoders is transmitted on no more than 4 of the 8 antenna ports to avoid redundant precoders. Example Embodiment 1 can be stated as a method of non-coherent multi-antenna transmission, comprising:
transmitting N layers on one or more antenna port subsets of a set of 8 ports according to at least a first precoder of a set of precoders for N layers, wherein
   N is at least two and is no more than 8,
   Each antenna port subset comprises two antenna ports,
   Each antenna port is present in only one antenna port subset,
   There is at most one antenna port subset with one active antenna port, and the remaining subsets have either no active antenna ports or two active antenna ports.
   Each antenna port is transmitted on one and only one layer when the first precoder is used, and
   A same layer in each precoder of the set of precoders is transmitted on no more than 4 of the 8 antenna ports

### Example Embodiment 2

In this example embodiment, the codebook targets both N_{g}=2 and 4 with a mix of precoders for a given number of layers; for ranks 3 and 4, N_{g}=2 case has one of either {0,1} or {2,3} ports active for the first polarization, while N_{g}=4 has {0,1}, {0,2}, {0,3}, {1,2}, {1,3} or {2,3} ports active. Example Embodiment 2 can be stated as the method of Example Embodiment 1, wherein:
for the first precoder of the set of precoders for N layers, transmission is on at least
   a combination {p₁, p₂} of a first antenna port p₁ of a first antenna port subset of the antenna port subsets and a first antenna port p₂ of a second antenna port subset of the antenna port subsets with {p₁, p₂}={0,1}, or {2,3}
for a second precoder of the set of precoders for N layers, transmission is on at least
   a combination {p₃, p₄} of a first antenna port p₃ of a first antenna port subset of the antenna port subsets and a first antenna port p₄ of a second antenna port subset of the antenna port subsets with {p₃, p₄}={0,1}, {0,2}, {0,3}, {1,2}, {1,3} or {2,3}.

### Example Embodiment 3

In this example embodiment, the codebook for N_{g}=1 has a mix of precoders for a given number of layers, where for rank 2, 3 and 4, Ne {2,3,4}, ports from {0,1,2,3} are active for the first polarization such that the difference between any two active port numbers is pⱼ−pᵢ>1, j>i. Example Embodiment 3 can be stated as the method of Example Embodiment 1, wherein
for the first precoder of the set of precoders for N layers, transmission is on at least a first antenna port p₁ of a first antenna port subset of the antenna port subsets and a first antenna port p₂ of a second antenna port subset of the antenna port subsets with {p₁, p₂}={0,2}, {0, 3} or {1, 3}, and
when at least 3 layers are transmitted, a different antenna port p′₁ of the first antenna port subset is additionally transmitted upon.

### Example Embodiment 4

In this example embodiment, the codebook for N_{g}={1,2,4} has a mix of precoders for a given number of layers, where for rank ∈{5,6}, ┌┐, N>4, ports from {0,1,2,3} are active for the first polarization. Example Embodiment 4 can be stated as the method of Example Embodiment 1 or 3, wherein when N=5 or N=6 layers are transmitted,
for the first precoder of the set of precoders for N layers, transmission is on at least a first antenna port p₁ of a first antenna port subset of the antenna port subsets, a first antenna port p₂ of a second antenna port subset of the antenna port subsets, and a third antenna port p₃ of a third antenna port subset of the antenna port subsets with {p₁, p₂, p₃}={0,1,2}, {0,1,3}, {0,2,3}, or {1,2,3} and
a different antenna port p′₂ of the second antenna port subset is additionally transmitted upon.

Certain embodiments may provide one or more of the following technical advantage(s). The proposed solution provides the design for a reduced number of NC precoders to limit the DCI signaling overhead, with a negligible loss in the performance. Further, the reduced number of NC precoders allow the nesting with FC or PC precoders with a limited increase in the overhead.

Now, the description turns to a more detailed description of embodiments of the present disclosure.

In the following, subset restriction for NC precoders for 8 Tx transmission and for the case when the transmission rank is 1≤rank≤8 is considered. Moreover, the NC precoders can be nested with FC or PC precoders to provide power-saving capability to a UE deployed with 8 Tx antenna ports. The embodiments for the design of NC precoders are first discussed followed by embodiments related to signaling the nested FC and NC precoders.

In the following, precoder designs are described using the 3GPP notion of antenna ports. While one or more of the UE's transmit chains may be mapped to each antenna port, for concreteness, embodiments herein are described with one Tx chain mapped to a corresponding antenna port.

While strictly speaking the term Transmit Precoding Matrix Index (TPMI) in 3GPP specifications is an indication of a precoding matrix, embodiments herein also may use the term TPMI to refer to the precoder (or equivalently, the precoding matrix) indicated by a TPMI.

Note that the exact antenna port numbering for an 8 Tx UE have not yet been decided in 3GPP. Embodiments below are described (e.g., when designing precoding matrices) using an exemplary antenna-port numbering scheme that is likely to be agreed. If another antenna-port numbering scheme is instead used, the corresponding precoding matrices can be obtained by multiplying precoding matrices herein with a permutation matrix.

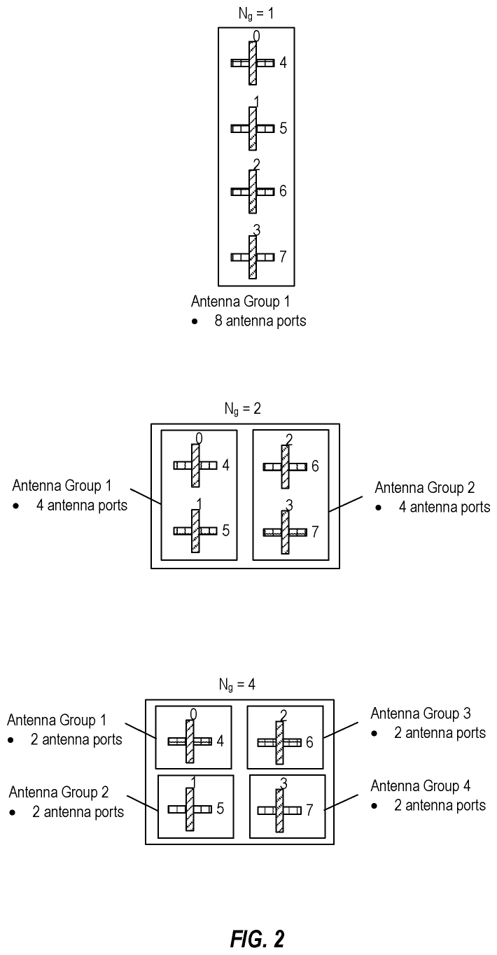

Specifically, in the following examples for UE with 8 Tx antenna ports, the antenna port numbers {0,1,2,3} and {4,5,6,7} belong to different polarizations and are shown in different pattern fills, as in FIG. 2, with ports {0,4}, {1,5}, {2,6} and {3,7} forming dual polarized antenna ports. Further, FIG. 2 shows the antenna configurations agreed for the study in Rel-18, where the 8 Tx antenna ports can be divided into one, two or four antenna groups, denoted by N_{g}, with eight, four or two antenna ports each, respectively.

Note that the embodiments are formulated to (1) facilitate UE transmission with rank >1 with uncontrolled phase between the antenna ports by mapping a given antenna port to only one layer and/or (2) allow antenna group selection (to avoid group(s) with poor channel condition), when the antenna ports are divided into multiple antenna groups.

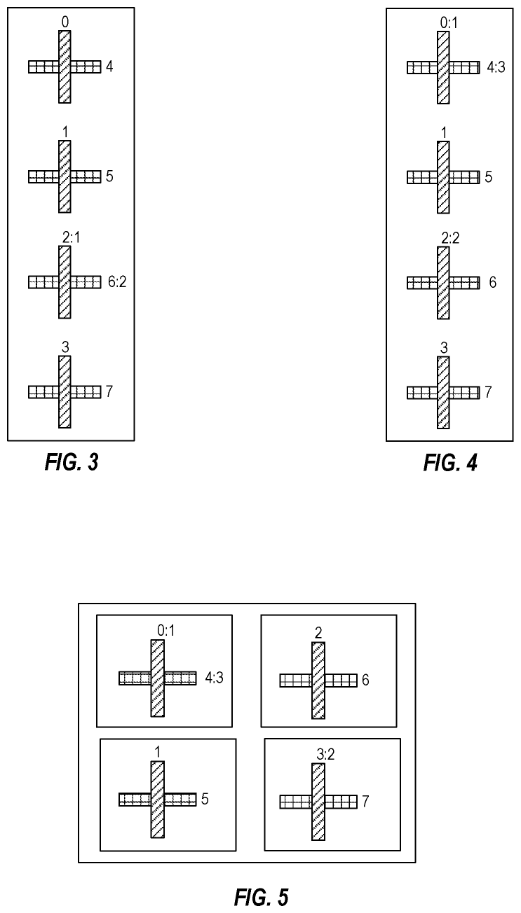

In one embodiment, the NC precoders are designed such that each port in an xpol (cross-polarized) pair is transmitted for all xpol pairs for an even number of layers, and all but one xpol pair for an odd number of layers, where each port in an xpol pair is on a different layer. A given layer in each precoder of the set of precoders is transmitted on no more than 4 of the 8 antenna ports to avoid redundant precoders. For example, with transmission rank N, ┌┐ and (N—┌┐) ports are active from first and second polarization, respectively. One example for rank 2 is shown in FIG. 3. FIG. 3 illustrates transmission for two layers, where the port 2 is transmitted on one layer from the first polarization and the port 6 is transmitted on one layer from the second polarization. Here, the port transmitting the configured layer is denoted by ‘port number:layer number’.

It can be desirable to concentrate the ports that are transmitted upon (the ‘active ports’) to fill up the xpol pairs as much as possible, that is transmit on both polarizations of a given element of the antenna array. UE antenna arrays can be directional, where each element has a different boresight, but it is common in such cases to have both polarizations use the same boresight. By filling the elements, the power is maximized along the direction of the boresights, and interference can be avoided toward receiving gNBs. This filling up of polarizations requires that each port in an xpol pair is transmitted for all xpol pairs if an even number of layers is transmitted, while for an odd number of transmitted layers, there is at most one xpol pair that carries one layer.

By restricting the first layer to contain only the first 4 ports (0-3) for rank 2 or higher, redundant precoders are not used in the codebook. This can be understood by comparing precoders ‘TPMIOa’ and ‘TPMIOb’ below. TPMIOa occupies port 0 and port 4, respectively for layers 1 and 2, while TPMIOb occupies port 4 and port 0, respectively for layers 1 and 2. Because a given MIMO codeword will carry modulation symbols from both layers 1 and 2, and the modulation order is the same on the two layers, then permuting the columns from TPMIOa to TPMIOb will not change the performance. Therefore, it can be seen that constraining the first layer to contain only the first 4 ports avoids the need of having precoders that are formed by permuting the layers of other precoders in a codebook, and allows the same performance with a smaller codebook than if the permuted precoders were included.

$$TPMI 0 a = \frac{0}{2 \sqrt{2}} \vert \begin{matrix}1 & 0 \\ 0 & 0 \\ 0 & 0 \\ 0 & 0 \\ 0 & 1 \\ 0 & 0 \\ 0 & 0 \\ 0 & 0\end{matrix} \vert TMPI 0 b = \frac{1}{2 \sqrt{2}} \vert \begin{matrix}0 & 1 \\ 0 & 0 \\ 0 & 0 \\ 0 & 0 \\ 1 & 0 \\ 0 & 0 \\ 0 & 0 \\ 0 & 0\end{matrix} \vert$$

In a dependent embodiment, the NC precoders, for rank N≤4, are designed such that ┐┌ ports are active for the first polarization with the difference between any two active port number (denoted by pᵢ, i ∈{0,1,2,3}) is pⱼ−pᵢ>1, j>i, that is, the ports have non-adjacent indices. For example, with transmission rank 3 and 4, the NC precoders can be designed such that ports {p₁, p₂}={0, 2}, {0, 3} or {1, 3} are transmitted on one layer each. One example for rank 3 is shown in FIG. 4. FIG. 4 illustrates transmission for three layers, where port numbers {0, 2} are transmitted on one layer each from the first polarization and port 4 is transmitted on one layer from the second polarization. Here, the port transmitting the configured layer is denoted by ‘port number:layer number’.

By using non-adjacent ports with a uniform linear array of antenna elements pointing in the same direction, the antenna elements may be further apart than the case where the ports are adjacent. This greater distance can improve spatial diversity, since elements that are further apart tend to be less correlated, allowing more diversity. Alternatively, if a pair of back-to back panels is used, non-adjacent ports will tend to be on different panels, and layers will be transmitted in different directions according to where the panels point. This can improve spatial diversity as well, since the signals will propagate over different directions to receivers in the network.

In another dependent embodiment, the NC codebook is designed to be compatible with where the antenna ports are grouped in different antenna groups, i.e., N_{g}∈{2,4} and when the rankN∈{3,4}, the NC precoders are designed such that the layers are transmitted from one or a subset of antenna groups. That is, for rank N≤4 different precoders are designed to support the cases with different values of N_{g}:
For N_{g}=2, the

$$⌈ \frac{N}{2} ⌉$$

first active ports of the xpol pairs are either one of {0,1} or {2,3} for rankN∈{3, 4}.
For N_{g}=4, the

$$⌈ \frac{N}{2} ⌉$$

first active ports of the xpol pairs are either one of {0,1}, {0, 2}, {0, 3}, {1,2}, {1,3} or {2,3} for rankN∈{3, 4}.
   One example for rank 3 with N_{g}=4 is shown in FIG. 5. FIG. 5 illustrates transmission for three layers with N_{g}=4, where port numbers {0, 3} are transmitted on one layer each from the first polarization and port 4 is transmitted on one layer from the second polarization, such that only group 1 and 4 are active. Here, the port transmitting the configured layer is denoted by ‘port number:layer number’.

By transmitting on a subset of the antenna groups in this way, the groups with the best channel conditions can be used. If two groups are used (N_{g}=2) with a rank 3 transmission, precoders are designed for transmission over one group when the first

$$⌈ \frac{N}{2} ⌉$$

ports of the xpol pairs are either one of {0,1} or {2,3}. If four groups are used (N_{g}=4) with a rank 3 transmission, precoders are designed for transmission over two groups when the first

$$⌈ \frac{N}{2} ⌉$$

ports of the xpol pairs are either one of {0,1}, {0, 2}, {0, 3}, {1,2}, {1,3} or {2,3}.

In another dependent embodiment, when the rankN∈{5,6}, the NC precoders are designed such that

$$⌈ \frac{N}{2} ⌉$$

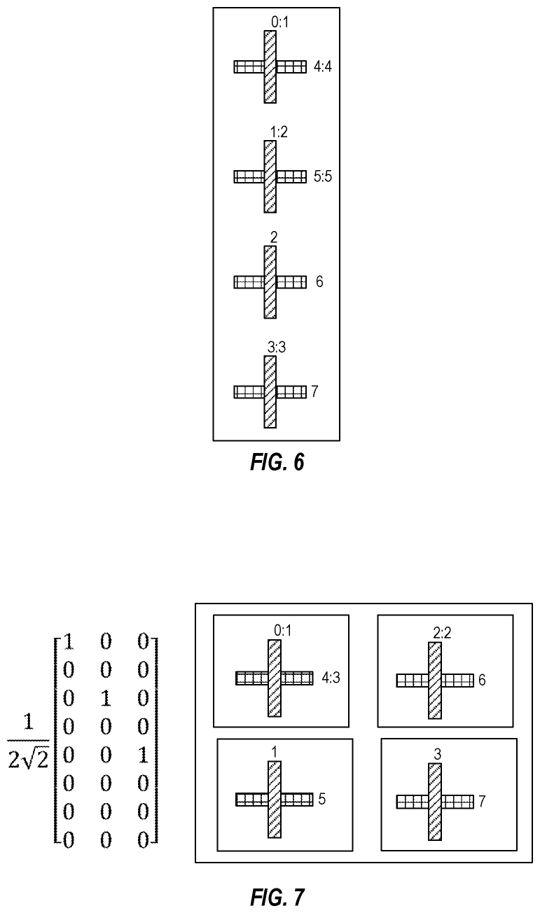

ports are active for the first polarization, where the first ports of the xpol pairs can be all or subset of {0,1,2,3} with pᵢ₊₁−pᵢ>0. With transmission rankN∈{5, 6}, the NC precoders can be designed such that ports {p₁, p₂, p₃}={0, 1, 2}, {0, 1, 3}, {0, 2, 3}, {1, 2, 3} are transmitted on one layer each. One example for rank 5 is shown in FIG. 6. FIG. 6 illustrates transmission for five layers, where ports {0, 1, 3} are transmitted on one layer each from the first polarization and ports {4,5} are transmitted on one layer each from the second polarization. Here, the port transmitting the configured layer is denoted by ‘port number:layer number’.

In this example, when the rank is 5 or 6, the third antenna element containing ports 2 and 6 is inactive. This improves the diversity of the transmission by having greater separation among the antenna elements:layer 3 is carried on the last element, while layers {0, 1, 2, and 4} are on one of the first and second elements. If layer 3 were carried on the third element, it would be adjacent to the second, and therefore could be more correlated, reducing the diversity gain.

Based on the above embodiments, NC precoders for rank 1-8 with 32, 16 and 8 candidates are given in Table 5, Table 6, and Table 7, respectively, below.

TABLE 5
NC precoders with 32 candidates

| Rank | NC precoder candidates |
|---|---|
| 1 | $\frac{1}{2 \sqrt{2}} [ \begin{matrix}1 \\ 0 \\ 0 \\ 0 \\ 0 \\ 0 \\ 0 \\ 0\end{matrix} ] ; \frac{1}{2 \sqrt{2}} [ \begin{matrix}0 \\ 0 \\ 0 \\ 1 \\ 0 \\ 0 \\ 0 \\ 0\end{matrix} ] ; \frac{1}{2 \sqrt{2}} [ \begin{matrix}0 \\ 0 \\ 0 \\ 0 \\ 1 \\ 0 \\ 0 \\ 0\end{matrix} ] ; \frac{1}{2 \sqrt{2}} [ \begin{matrix}0 \\ 0 \\ 0 \\ 0 \\ 0 \\ 0 \\ 0 \\ 1\end{matrix} ] ; \frac{1}{2 \sqrt{2}} [ \begin{matrix}0 \\ 1 \\ 0 \\ 0 \\ 0 \\ 0 \\ 0 \\ 0\end{matrix} ] ; \frac{1}{2 \sqrt{2}} [ \begin{matrix}0 \\ 0 \\ 1 \\ 0 \\ 0 \\ 0 \\ 0 \\ 0\end{matrix} ] ; \frac{1}{2 \sqrt{2}} [ \begin{matrix}0 \\ 0 \\ 0 \\ 0 \\ 0 \\ 1 \\ 0 \\ 0\end{matrix} ] ; \frac{1}{2 \sqrt{2}} [ \begin{matrix}0 \\ 0 \\ 0 \\ 0 \\ 0 \\ 0 \\ 1 \\ 0\end{matrix} ]$ |
| 2 | $\frac{1}{2 \sqrt{2}} [ \begin{matrix}1 & 0 \\ 0 & 0 \\ 0 & 0 \\ 0 & 0 \\ 0 & 1 \\ 0 & 0 \\ 0 & 0 \\ 0 & 0\end{matrix} ] ; \frac{1}{2 \sqrt{2}} [ \begin{matrix}0 & 0 \\ 1 & 0 \\ 0 & 0 \\ 0 & 0 \\ 0 & 0 \\ 0 & 1 \\ 0 & 0 \\ 0 & 0\end{matrix} ] ; \frac{1}{2 \sqrt{2}} [ \begin{matrix}0 & 0 \\ 0 & 0 \\ 1 & 0 \\ 0 & 0 \\ 0 & 0 \\ 0 & 0 \\ 0 & 1 \\ 0 & 0\end{matrix} ] ; \frac{1}{2 \sqrt{2}} [ \begin{matrix}1 & 0 \\ 0 & 0 \\ 0 & 1 \\ 0 & 0 \\ 0 & 0 \\ 0 & 0 \\ 0 & 0 \\ 0 & 0\end{matrix} ] ; \frac{1}{2 \sqrt{2}} [ \begin{matrix}0 & 0 \\ 1 & 0 \\ 0 & 0 \\ 0 & 1 \\ 0 & 0 \\ 0 & 0 \\ 0 & 0 \\ 0 & 0\end{matrix} ] ; \frac{1}{2 \sqrt{2}} [ \begin{matrix}0 & 0 \\ 0 & 0 \\ 0 & 0 \\ 1 & 0 \\ 0 & 0 \\ 0 & 0 \\ 0 & 0 \\ 0 & 1\end{matrix} ]$ |
| 3 | $\frac{1}{2 \sqrt{2}} [ \begin{matrix}1 & 0 & 0 \\ 0 & 0 & 0 \\ 0 & 1 & 0 \\ 0 & 0 & 0 \\ 0 & 0 & 1 \\ 0 & 0 & 0 \\ 0 & 0 & 0 \\ 0 & 0 & 0\end{matrix} ] ; \frac{1}{2 \sqrt{2}} [ \begin{matrix}0 & 0 & 0 \\ 1 & 0 & 0 \\ 0 & 0 & 0 \\ 0 & 1 & 0 \\ 0 & 0 & 0 \\ 0 & 0 & 1 \\ 0 & 0 & 0 \\ 0 & 0 & 0\end{matrix} ] ; \frac{1}{2 \sqrt{2}} [ \begin{matrix}0 & 0 & 0 \\ 0 & 0 & 0 \\ 1 & 0 & 0 \\ 0 & 1 & 0 \\ 0 & 0 & 0 \\ 0 & 0 & 0 \\ 0 & 0 & 1 \\ 0 & 0 & 0\end{matrix} ] ; \frac{1}{2 \sqrt{2}} [ \begin{matrix}1 & 0 & 0 \\ 0 & 0 & 0 \\ 0 & 0 & 0 \\ 0 & 1 & 0 \\ 0 & 0 & 1 \\ 0 & 0 & 0 \\ 0 & 0 & 0 \\ 0 & 0 & 0\end{matrix} ] ; \frac{1}{2 \sqrt{2}} [ \begin{matrix}0 & 0 & 0 \\ 1 & 0 & 0 \\ 0 & 1 & 0 \\ 0 & 0 & 0 \\ 0 & 0 & 0 \\ 0 & 0 & 1 \\ 0 & 0 & 0 \\ 0 & 0 & 0\end{matrix} ] ; \frac{1}{2 \sqrt{2}} [ \begin{matrix}1 & 0 & 0 \\ 0 & 1 & 0 \\ 0 & 0 & 0 \\ 0 & 0 & 0 \\ 0 & 0 & 1 \\ 0 & 0 & 0 \\ 0 & 0 & 0 \\ 0 & 0 & 0\end{matrix} ]$ |
| 4 | $\frac{1}{2 \sqrt{2}} [ \begin{matrix}1 & 0 & 0 & 0 \\ 0 & 0 & 0 & 0 \\ 0 & 1 & 0 & 0 \\ 0 & 0 & 0 & 0 \\ 0 & 0 & 1 & 0 \\ 0 & 0 & 0 & 0 \\ 0 & 0 & 0 & 1 \\ 0 & 0 & 0 & 0\end{matrix} ] ; \frac{1}{2 \sqrt{2}} [ \begin{matrix}0 & 0 & 0 & 0 \\ 1 & 0 & 0 & 0 \\ 0 & 0 & 0 & 0 \\ 0 & 1 & 0 & 0 \\ 0 & 0 & 0 & 0 \\ 0 & 0 & 1 & 0 \\ 0 & 0 & 0 & 0 \\ 0 & 0 & 0 & 1\end{matrix} ] ; \frac{1}{2 \sqrt{2}} [ \begin{matrix}1 & 0 & 0 & 0 \\ 0 & 1 & 0 & 0 \\ 0 & 0 & 0 & 0 \\ 0 & 0 & 0 & 0 \\ 0 & 0 & 1 & 0 \\ 0 & 0 & 0 & 1 \\ 0 & 0 & 0 & 0 \\ 0 & 0 & 0 & 0\end{matrix} ] ; \frac{1}{2 \sqrt{2}} [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 0 & 0 \\ 0 & 0 & 0 & 0 \\ 0 & 0 & 1 & 0 \\ 0 & 0 & 0 & 1\end{matrix} ]$ |
| 5 | $\frac{1}{2 \sqrt{2}} [ \begin{matrix}1 & 0 & 0 & 0 & 0 \\ 0 & 1 & 0 & 0 & 0 \\ 0 & 0 & 0 & 0 & 0 \\ 0 & 0 & 1 & 0 & 0 \\ 0 & 0 & 0 & 1 & 0 \\ 0 & 0 & 0 & 0 & 1 \\ 0 & 0 & 0 & 0 & 0 \\ 0 & 0 & 0 & 0 & 0\end{matrix} ] ; \frac{1}{2 \sqrt{2}} [ \begin{matrix}1 & 0 & 0 & 0 & 0 \\ 0 & 1 & 0 & 0 & 0 \\ 0 & 0 & 0 & 0 & 0 \\ 0 & 0 & 1 & 0 & 0 \\ 0 & 0 & 0 & 0 & 0 \\ 0 & 0 & 0 & 1 & 0 \\ 0 & 0 & 0 & 0 & 0 \\ 0 & 0 & 0 & 0 & 1\end{matrix} ] ; \frac{1}{2 \sqrt{2}} [ \begin{matrix}0 & 0 & 0 & 0 & 0 \\ 1 & 0 & 0 & 0 & 0 \\ 0 & 1 & 0 & 0 & 0 \\ 0 & 0 & 1 & 0 & 0 \\ 0 & 0 & 0 & 0 & 0 \\ 0 & 0 & 0 & 1 & 0 \\ 0 & 0 & 0 & 0 & 0 \\ 0 & 0 & 0 & 0 & 1\end{matrix} ] ; \frac{1}{2 \sqrt{2}} [ \begin{matrix}1 & 0 & 0 & 0 & 0 \\ 0 & 1 & 0 & 0 & 0 \\ 0 & 0 & 0 & 0 & 0 \\ 0 & 0 & 1 & 0 & 0 \\ 0 & 0 & 0 & 0 & 0 \\ 0 & 0 & 0 & 0 & 0 \\ 0 & 0 & 0 & 1 & 0 \\ 0 & 0 & 0 & 0 & 1\end{matrix} ] ;$ |
| 6 | $\frac{1}{2 \sqrt{2}} [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1 \\ 0 & 0 & 0 & 0 & 0 & 0\end{matrix} ] ; \frac{1}{2 \sqrt{2}} [ \begin{matrix}0 & 0 & 0 & 0 & 0 & 0 \\ 1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} ]$ |
| 7 | $\frac{1}{2 \sqrt{2}} [ \begin{matrix}1 & 0 & 0 & 0 & 0 & 0 & 0 \\ 0 & 1 & 0 & 0 & 0 & 0 & 0 \\ 0 & 0 & 1 & 0 & 0 & 0 & 0 \\ 0 & 0 & 0 & 1 & 0 & 0 & 0 \\ 0 & 0 & 0 & 0 & 1 & 0 & 0 \\ 0 & 0 & 0 & 0 & 0 & 1 & 0 \\ 0 & 0 & 0 & 0 & 0 & 0 & 1 \\ 0 & 0 & 0 & 0 & 0 & 0 & 0\end{matrix} ]$ |
| 8 | $\frac{1}{2 \sqrt{2}} [ \begin{matrix}1 & 0 & 0 & 0 & 0 & 0 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & 1 & 0 \\ 0 & 0 & 0 & 0 & 0 & 0 & 0 & 1\end{matrix} ]$ |

TABLE 6
NC precoder candidates with 16 candidates

| Rank | NC precoder candidates |
|---|---|
| 1 | $\frac{1}{2 \sqrt{2}} [ \begin{matrix}1 \\ 0 \\ 0 \\ 0 \\ 0 \\ 0 \\ 0 \\ 0\end{matrix} ] ; \frac{1}{2 \sqrt{2}} [ \begin{matrix}0 \\ 0 \\ 0 \\ 1 \\ 0 \\ 0 \\ 0 \\ 0\end{matrix} ] ; \frac{1}{2 \sqrt{2}} [ \begin{matrix}0 \\ 0 \\ 0 \\ 0 \\ 1 \\ 0 \\ 0 \\ 0\end{matrix} ] ; \frac{1}{2 \sqrt{2}} [ \begin{matrix}0 \\ 0 \\ 0 \\ 0 \\ 0 \\ 0 \\ 0 \\ 1\end{matrix} ]$ |
| 2 | $\frac{1}{2 \sqrt{2}} [ \begin{matrix}1 & 0 \\ 0 & 0 \\ 0 & 0 \\ 0 & 0 \\ 0 & 1 \\ 0 & 0 \\ 0 & 0 \\ 0 & 0\end{matrix} ] ; \frac{1}{2 \sqrt{2}} [ \begin{matrix}0 & 0 \\ 1 & 0 \\ 0 & 0 \\ 0 & 0 \\ 0 & 0 \\ 0 & 1 \\ 0 & 0 \\ 0 & 0\end{matrix} ] ; \frac{1}{2 \sqrt{2}} [ \begin{matrix}0 & 0 \\ 0 & 0 \\ 1 & 0 \\ 0 & 0 \\ 0 & 0 \\ 0 & 0 \\ 0 & 1 \\ 0 & 0\end{matrix} ]$ |
| 3 | $\frac{1}{2 \sqrt{2}} [ \begin{matrix}1 & 0 & 0 \\ 0 & 0 & 0 \\ 0 & 1 & 0 \\ 0 & 0 & 0 \\ 0 & 0 & 1 \\ 0 & 0 & 0 \\ 0 & 0 & 0 \\ 0 & 0 & 0\end{matrix} ] ; \frac{1}{2 \sqrt{2}} [ \begin{matrix}0 & 0 & 0 \\ 1 & 0 & 0 \\ 0 & 0 & 0 \\ 0 & 1 & 0 \\ 0 & 0 & 0 \\ 0 & 0 & 1 \\ 0 & 0 & 0 \\ 0 & 0 & 0\end{matrix} ] ; \frac{1}{2 \sqrt{2}} [ \begin{matrix}0 & 0 & 0 \\ 0 & 0 & 0 \\ 1 & 0 & 0 \\ 0 & 1 & 0 \\ 0 & 0 & 0 \\ 0 & 0 & 0 \\ 0 & 0 & 1 \\ 0 & 0 & 0\end{matrix} ]$ |
| 4 | $\frac{1}{2 \sqrt{2}} [ \begin{matrix}1 & 0 & 0 & 0 \\ 0 & 0 & 0 & 0 \\ 0 & 1 & 0 & 0 \\ 0 & 0 & 0 & 0 \\ 0 & 0 & 1 & 0 \\ 0 & 0 & 0 & 0 \\ 0 & 0 & 0 & 1 \\ 0 & 0 & 0 & 0\end{matrix} ] ; \frac{1}{2 \sqrt{2}} [ \begin{matrix}0 & 0 & 0 & 0 \\ 1 & 0 & 0 & 0 \\ 0 & 0 & 0 & 0 \\ 0 & 1 & 0 & 0 \\ 0 & 0 & 0 & 0 \\ 0 & 0 & 1 & 0 \\ 0 & 0 & 0 & 0 \\ 0 & 0 & 0 & 1\end{matrix} ]$ |
| 5 | $\frac{1}{2 \sqrt{2}} [ \begin{matrix}1 & 0 & 0 & 0 & 0 \\ 0 & 1 & 0 & 0 & 0 \\ 0 & 0 & 0 & 0 & 0 \\ 0 & 0 & 1 & 0 & 0 \\ 0 & 0 & 0 & 1 & 0 \\ 0 & 0 & 0 & 0 & 1 \\ 0 & 0 & 0 & 0 & 0 \\ 0 & 0 & 0 & 0 & 0\end{matrix} ] ;$ |
| 6 | $\frac{1}{2 \sqrt{2}} [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1 \\ 0 & 0 & 0 & 0 & 0 & 0\end{matrix} ]$ |
| 7 | $\frac{1}{2 \sqrt{2}} [ \begin{matrix}1 & 0 & 0 & 0 & 0 & 0 & 0 \\ 0 & 1 & 0 & 0 & 0 & 0 & 0 \\ 0 & 0 & 1 & 0 & 0 & 0 & 0 \\ 0 & 0 & 0 & 1 & 0 & 0 & 0 \\ 0 & 0 & 0 & 0 & 1 & 0 & 0 \\ 0 & 0 & 0 & 0 & 0 & 1 & 0 \\ 0 & 0 & 0 & 0 & 0 & 0 & 1 \\ 0 & 0 & 0 & 0 & 0 & 0 & 0\end{matrix} ]$ |
| 8 | $\frac{1}{2 \sqrt{2}} [ \begin{matrix}1 & 0 & 0 & 0 & 0 & 0 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & 1 & 0 \\ 0 & 0 & 0 & 0 & 0 & 0 & 0 & 1\end{matrix} ]$ |

TABLE 7
NC precoders with 8 candidates

| Rank | NC precoder candidates |
|---|---|
| 1 | $\frac{1}{2 \sqrt{2}} [ \begin{matrix}1 \\ 0 \\ 0 \\ 0 \\ 0 \\ 0 \\ 0 \\ 0\end{matrix} ]$ |
| 2 | $\frac{1}{2 \sqrt{2}} [ \begin{matrix}1 & 0 \\ 0 & 0 \\ 0 & 0 \\ 0 & 0 \\ 0 & 1 \\ 0 & 0 \\ 0 & 0 \\ 0 & 0\end{matrix} ]$ |
| 3 | $\frac{1}{2 \sqrt{2}} [ \begin{matrix}1 & 0 & 0 \\ 0 & 0 & 0 \\ 0 & 1 & 0 \\ 0 & 0 & 0 \\ 0 & 0 & 1 \\ 0 & 0 & 0 \\ 0 & 0 & 0 \\ 0 & 0 & 0\end{matrix} ]$ |
| 4 | $\frac{1}{2 \sqrt{2}} [ \begin{matrix}1 & 0 & 0 & 0 \\ 0 & 0 & 0 & 0 \\ 0 & 1 & 0 & 0 \\ 0 & 0 & 0 & 0 \\ 0 & 0 & 1 & 0 \\ 0 & 0 & 0 & 0 \\ 0 & 0 & 0 & 1 \\ 0 & 0 & 0 & 0\end{matrix} ]$ |
| 5 | $\frac{1}{2 \sqrt{2}} [ \begin{matrix}1 & 0 & 0 & 0 & 0 \\ 0 & 1 & 0 & 0 & 0 \\ 0 & 0 & 0 & 0 & 0 \\ 0 & 0 & 1 & 0 & 0 \\ 0 & 0 & 0 & 1 & 0 \\ 0 & 0 & 0 & 0 & 1 \\ 0 & 0 & 0 & 0 & 0 \\ 0 & 0 & 0 & 0 & 0\end{matrix} ] ;$ |
| 6 | $\frac{1}{2 \sqrt{2}} [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1 \\ 0 & 0 & 0 & 0 & 0 & 0\end{matrix} ]$ |
| 7 | $\frac{1}{2 \sqrt{2}} [ \begin{matrix}1 & 0 & 0 & 0 & 0 & 0 & 0 \\ 0 & 1 & 0 & 0 & 0 & 0 & 0 \\ 0 & 0 & 1 & 0 & 0 & 0 & 0 \\ 0 & 0 & 0 & 1 & 0 & 0 & 0 \\ 0 & 0 & 0 & 0 & 1 & 0 & 0 \\ 0 & 0 & 0 & 0 & 0 & 1 & 0 \\ 0 & 0 & 0 & 0 & 0 & 0 & 1 \\ 0 & 0 & 0 & 0 & 0 & 0 & 0\end{matrix} ]$ |
| 8 | $\frac{1}{2 \sqrt{2}} [ \begin{matrix}1 & 0 & 0 & 0 & 0 & 0 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & 1 & 0 \\ 0 & 0 & 0 & 0 & 0 & 0 & 0 & 1\end{matrix} ]$ |

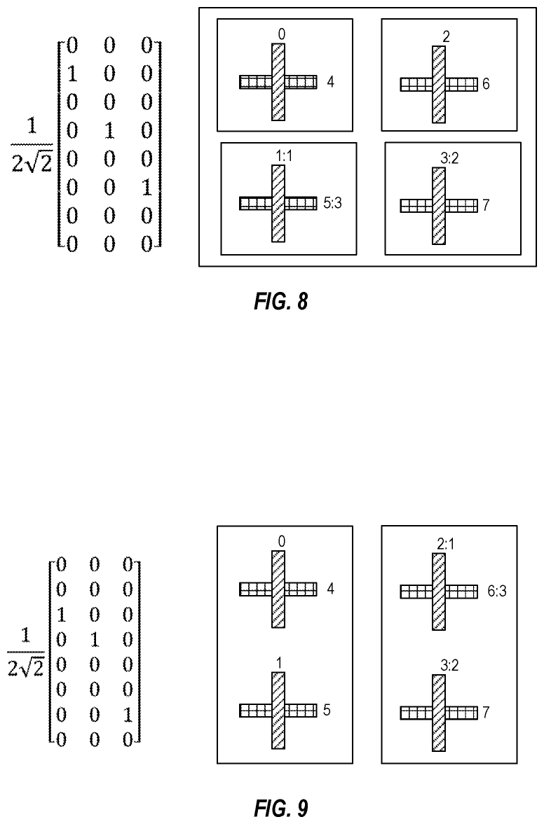

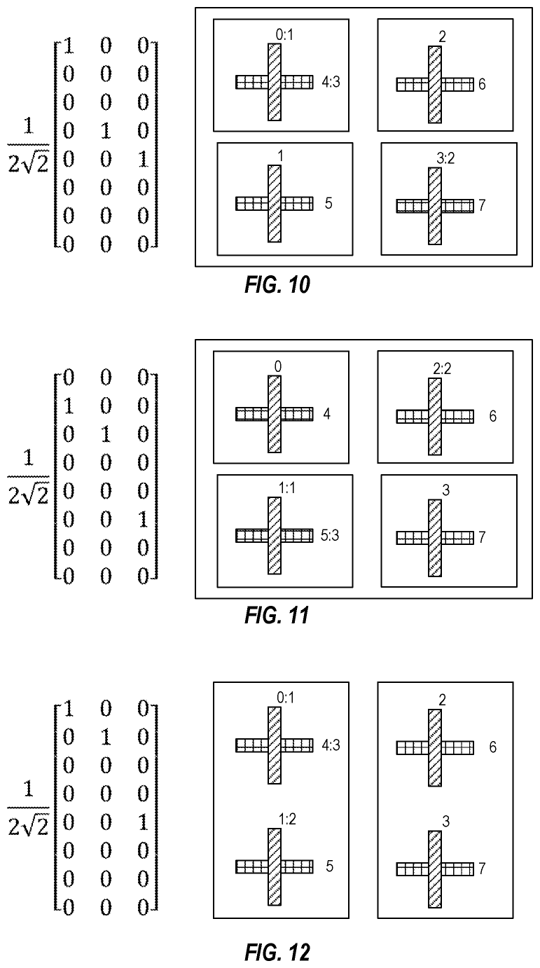

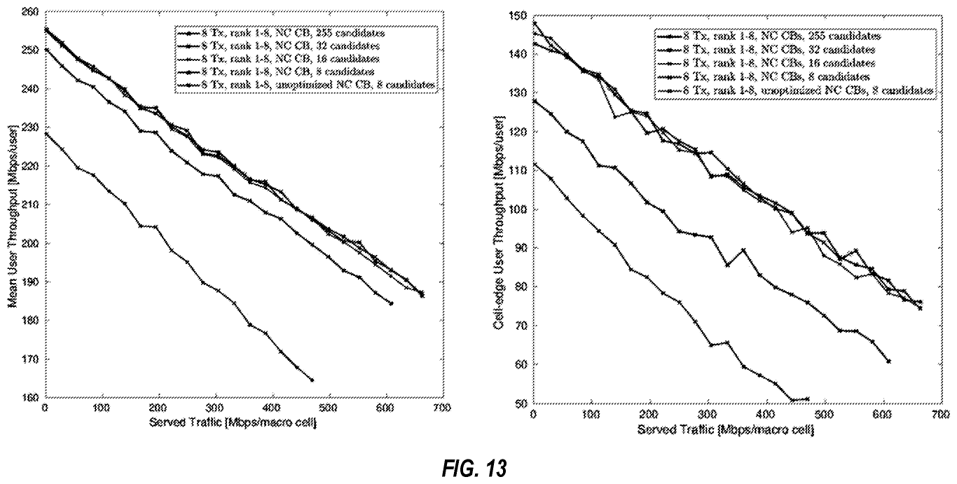

The NC precoders included in the tables follow at least one of the principles defined in the above embodiments, irrespective of the antenna configuration defined for 8 Tx, i.e., one, two or four antenna groups (N_{g}=1, 2 or 4). To exemplify the above, each TPMI for rank 3 in Table 5 is described next. In the following, the antenna port used for the first, second, and third layers is denoted with {p₁, p₂, p₃}
i. TPMI 1: Assuming the NC precoder is applied to 8 Tx antenna ports, where the antenna ports are grouped into four panels (each with a dual polarized antenna) pointing in different direction, the precoder is defined such that (as shown in FIG. 7):
   The 1^{st} and 3^{rd} layers are transmitted from the first antenna group but from different polarization.
   The 2^{nd} layer is transmitted from third antenna group pointing in different direction.
   The second and fourth antenna group are inactive.
   The first ports of the xpol pairs are {0,2}, while the second port of the first xpol pair is {4}, and so {p₁, p₂, p₃}={0,2,4}
In other words, FIG. 7 illustrates transmission for three layers, where the 8 Tx antenna ports are grouped into four antenna groups such that ports {0,4}, {1,5}, {2,6} and {3,7} belong to different groups. The layers are transmitted from port number {0, 4} and {2} such that only 1^{st} and 3^{rd} antenna groups are active. Here, the port transmitting the configured layer is denoted by ‘port number:layer number’.
ii. TPMI 2: Assuming the NC precoder is applied to 8 Tx antenna ports, where the antenna ports are grouped into four panels (each with a dual polarized antenna) pointing in different direction, the precoder is defined such that (as shown in FIG. 8):
   The 1^{st} and 3^{rd} layers are transmitted from second antenna group but from different polarization.
   The 2^{nd} layer is transmitted from fourth antenna group pointing in different direction.
   The first and third antenna group is inactive.
   The first ports of the xpol pairs are {1,3}, while the second port of the first xpol pair is {5}, and so {p₁, p₂, p₃}={1,3,5}
FIG. 8 illustrates transmission for three layers, where the 8 Tx antenna ports are grouped into four antenna groups such that ports {0,4}, {1,5}, {2,6} and {3,7} belong to different groups. The layers are transmitted from port number {1, 5} and {3} such that only 2^{nd} and 4^{th} antenna groups are active. Here, the port transmitting the configured layer is denoted by ‘port number:layer number’.
iii. TPMI 3: Assuming the NC precoder is applied to 8 Tx antenna ports, where the antenna ports are grouped into two back-to-back panels (each with 1×2 dual polarized ULA) pointing in different direction, the precoder is defined such that (as shown in FIG. 9):
   All the layers are transmitted from the second antenna group, where the 1^{st} and 3rd layers are transmitted from different polarization.
   The first antenna group is inactive.
   The first ports of the xpol pairs are {2,3}, while the second port of the first xpol pair is {6}, and so {p₁, p₂, p₃}={2,3,6}
FIG. 9 illustrates transmission for three layers, where the 8 Tx antenna ports are grouped into two antenna groups such that ports {0,1,4,5} and {2,3,6,7} belong to different groups. The layers are transmitted from port number {2,6} and {3} such that only 2^{nd} antenna group is active. Here, the port transmitting the configured layer is denoted by ‘port number:layer number’.
iv. TPMI 4: Assuming the NC precoder is applied to 8 Tx antenna ports, where the antenna ports are grouped into four panels (each with a dual polarized antenna) pointing in different direction, the precoder is defined such that (as shown in FIG. 10):
   The 1^{st} and 3^{rd} layers are transmitted from first antenna group but from different polarization.
   The 2^{nd} layer is transmitted from fourth antenna group pointing in different direction.
   The second and third antenna group is inactive.
   The first ports of the xpol pairs are {0,3}, while the second port of the first xpol pair is {4}, and so {p₁, p₂, p₃}={0,3,4}
FIG. 10 illustrates transmission for three layers, where the 8 Tx antenna ports are grouped into four antenna groups such that ports {0,4}, {1,5}, {2,6} and {3,7} belong to different groups. The layers are transmitted from port number {0, 4} and {3} such that only 1^{st} and 4^{th} antenna groups are active. Here, the port transmitting the configured layer is denoted by ‘port number:layer number’.
v. TPMI 5: Assuming the NC precoder is applied to 8 Tx antenna ports, where the antenna ports are grouped into four panels (each with a dual polarized antenna) pointing in different direction, the precoder is defined such that (as shown in FIG. 11):
   The 1^{st} and 3^{rd} layers are transmitted from second antenna group but from different polarization.
   The 2^{nd} layer is transmitted from third antenna group pointing in different direction.
   The first and fourth antenna group is inactive.
   The first ports of the xpol pairs are {1,2}, while the second port of the first xpol pair is {5}, and so {p₁, p₂, p₃}={1,2,5}
FIG. 11 illustrates transmission for three layers, where the 8 Tx antenna ports are grouped into four antenna groups such that ports {0,4}, {1,5}, {2,6} and {3,7} belong to different groups. The layers are transmitted from port number {1, 5} and {2} such that only 2^{nd} and 3^{rd} antenna groups are active. Here, the port transmitting the configured layer is denoted by ‘port number:layer number’.
vi. TPMI 6: Assuming the NC precoder is applied to 8 Tx antenna ports, where the antenna ports are grouped into two back-to-back panels (each with 1×2 dual polarized ULA), the precoder is defined such that (as shown in FIG. 12):
   All the layers are transmitted from the first antenna group, where the 1^{st} and 3^{rd} layers are transmitted from different polarization.
   The second antenna group is inactive.
   The first ports of the xpol pairs are {0,1}, while the second port of the first xpol pair is {4}, and so {p₁, p₂, p₃}={0,1,4}
FIG. 12 illustrates transmission for three layers, where the 8 Tx antenna ports are grouped into two antenna groups such that ports {0,1,4,5} and {2,3,6,7} belong to different groups. The layers are transmitted from port number {0, 4} and {1} such that only 1^{st} antenna group is active. Here, the port transmitting the configured layer is denoted by ‘port number:layer number’.

Further note that:
When the 8 Tx antenna ports are arranged in a ULA, a TPMI {1,2,4} transmits the 1^{st} and 2^{nd} layers from non-consecutive antenna ports with same polarization, and 3^{rd} layer from a different polarization.
When the 8 Tx antenna ports are arranged in a UPA, TPMI 2 transmit the 1^{st} and 2^{nd} layers from non-consecutive antenna ports with same polarization, and 3^{rd} layer from a different polarization.

For 4 layer transmission, TPMIs 1-4 in Table 5 (numbered from left to right) behave as follows, where the antenna port used for the first, second, third, and fourth layers is denoted with {p₁, p₂, p₃, p₄}
TPMI 1: The first antenna ports of the xpol pairs are {0,2} while the second antenna ports of the xpol pairs are {4,6}, and so {p₁, p₂, p₃, p₄}={0,2,4,6}.
TPMI 2: The first antenna ports of the xpol pairs are {1,3} while the second antenna ports of the xpol pairs are {5,7}, and so {p₁, p₂, p₃, p₄}={1,3,5,7}.
TPMI 3: The first antenna ports of the xpol pairs are {0,1} while the second antenna ports of the xpol pairs are {4,5}, and so {p₁, p₂, p₃, p₄}={0,1,4,5}.
TPMI 4: The first antenna ports of the xpol pairs are {2,3} while the second antenna ports of the xpol pairs are {6,7}, and so {p₁, p₂, p₃, p₄}={2,3,6,7}.
For 5 layer transmission, TPMIs 1-4 in Table 5 (numbered from left to right) behave as follows, where the antenna port used for the first, second, third, fourth, and fifth layers is denoted with {p₁, p₂, p₃, p₄, p₅}
TPMI 1: The first antenna ports of the xpol pairs are {0,1,3} while the second antenna ports of the xpol pairs are {4,5}, and so {p₁, p₂, p₃, p₄, p₅}={0,1,3,4,5}.
TPMI 2: The first antenna ports of the xpol pairs are {0,1,3} while the second antenna ports of the xpol pairs are {5,7}, and so {p₁, p₂, p₃, p₄, p₅}={0,1,3,5,7}.
TPMI 3: The first antenna ports of the xpol pairs are {1,2,3} while the second antenna ports of the xpol pairs are {5,6}, and so {p₁, p₂, p₃, p₄, p₅}={1,2,3,5,6}.
TPMI 4: The first antenna ports of the xpol pairs are {1,2,3} while the second antenna ports of the xpol pairs are {6,7}, and so {p₁, p₂, p₃, p₄, p₅}={1,2,3,6,7}.

For 6 layer transmission, TPMIs 1 and 2 in Table 5 (numbered from left to right) behave as follows, where the antenna port used for the first, second, third, fourth, fifth, and sixth layers is denoted with {p₁, p₂, p₃, p₄, p₅, p₆}
TPMI 1: The first antenna ports of the xpol pairs are {0,1,2} while the second antenna ports of the xpol pairs are {4,5,6}, and so {p₁, p₂, p₃, p₄, p₅, p₆}={0,1,2,4,5,6}.
TPMI 2: The first antenna ports of the xpol pairs are {1,2,3} while the second antenna ports of the xpol pairs are {5,6,7}, and so {p₁, p₂, p₃, p₄, p₅, p₆}={1,2,3,5,6,7}.

The number of candidate NC precoders in a codebook per transmission rank for the NC precoders with maximum (255), 32, 16 and 8 candidates are summarized in Table 8.

TABLE 8
Codebook size for 8 Tx NC precoder candidates per rank.

| | NC precoders | NC precoders | NC precoders | NC precoders |
|---|---|---|---|---|
| | with maximum | with 32 | with 16 | with 8 |
| r | 255 candidates | candidates | candidates | candidates |
| 1 | 8 | 8 | 4 | 1 |
| 2 | 28 | 6 | 3 | 1 |
| 3 | 56 | 6 | 3 | 1 |
| 4 | 70 | 4 | 2 | 1 |
| 5 | 56 | 4 | 1 | 1 |
| 6 | 28 | 2 | 1 | 1 |
| 7 | 8 | 1 | 1 | 1 |
| 8 | 1 | 1 | 1 | 1 |
| ≤ 4 | 162 | 24 | 12 | 4 |
| ≤ 8 | 255 | 32 | 16 | 8 |

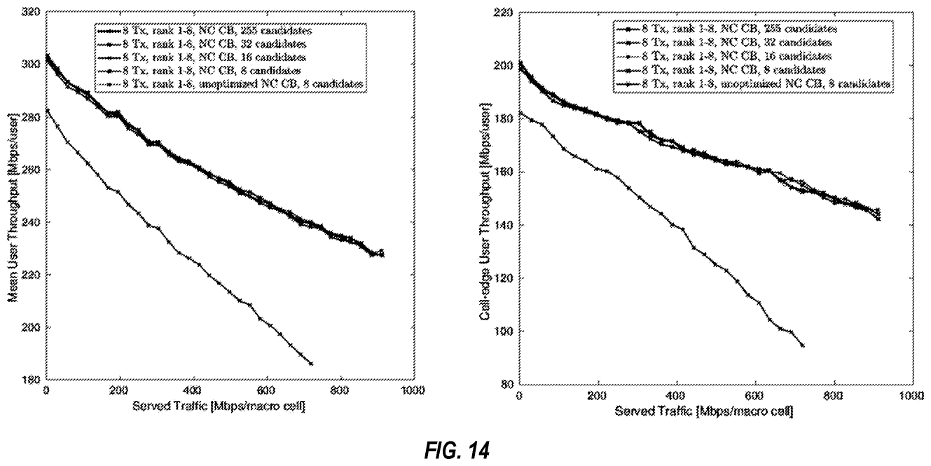

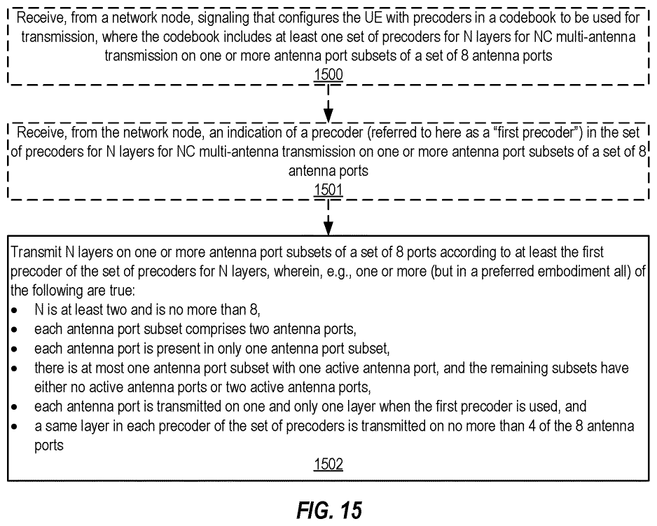

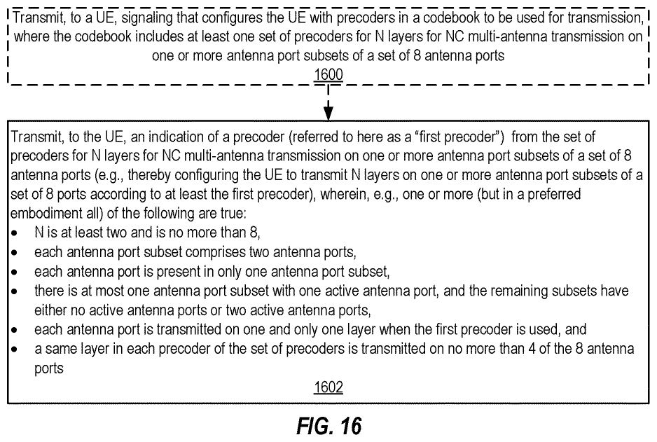

In the following, the above alternative codebook designs are evaluated. FIG. 13 shows the performance of the NC designs discussed above for an indoor UMi scenario, where all the UE are deployed indoor resulting in a low SINR transmission. The 8 Tx antenna ports are grouped into four antenna groups, which are arranged as four dual polarized antenna ports pointing in four different directions. As a baseline, an unoptimized design for NC precoders with 8 candidates are considered, where there is only one precoder per rank with the NC precoder for rank r is formed with ones in the first r diagonal elements and zeros on the remaining elements. It can be observed that the NC design with 32 and 16 candidates performs close to the NC precoders with a maximum number of candidates. Further, though there is a performance loss for NC precoders with 8 candidates, they perform significantly better than the unoptimized NC precoders with 8 candidates. Next, in FIG. 14, the same setup is evaluated for an outdoor UMa scenario, where all the UEs are deployed outdoor resulting in high SINR transmission. It can be observed that the NC precoders with 32, 16 and 8 candidates perform close to the NC precoders with a maximum number of candidates, while having a large gain over unoptimized NC precoders with 8 candidates. The above results demonstrate the advantage of the NC precoder design discussed in the present disclosure.

FIG. 13: Mean and cell-edge user UL throughout versus served traffic, comparing different NC codebook designs in an indoor UMi scenario for N_{g}=4. Here, the bandwidth is set to 100 MH2, Pₘₐₓ=23 dBm, and P₀=−80 with four dual polarized antenna ports pointing in four different directions deployed at the UE. The remaining SLS parameters are collected in the Appendix of R1-2303660 “SRI/TPMI Enhancements for Enabling 8 TX UL Transmission”, April 2023.

FIG. 14: Mean and cell-edge user UL throughout versus served traffic, comparing different NC codebook designs in an outdoor UMa scenario for N_{g}=4. Here, the bandwidth is set to 100 MHz, Pₘₐₓ=32 dBm, and P₀=−80 with four dual polarized antenna ports pointing in four different directions deployed at the UE. The remaining SLS parameters are collected in the Appendix of R1-2303660 “SRI/TPMI Enhancements for Enabling 8 TX UL Transmission”, April 2023.

Note that though in the embodiments described herein, the NC precoders with 32, 16 and 8 candidates are discussed, the same principle can be applied to NC precoders with a different number of candidates.

FIG. 15 is a flow chart that illustrates the operation of a UE in accordance with at least some of the embodiments described herein. Optional steps are represented by dashed lines/boxes. As illustrated, the UE first receives signaling from a network node (e.g., a base station such as, e.g., a gNB) configuring the UE with precoders in a codebook to be used for transmission (step 1500). The codebook contains at least one set of precoders for N layers for NC multi-antenna transmission on one or more antenna port subsets of a set of eight (8) antenna ports. The UE also receives an indication (e.g., a TPMI, but not limited thereto) from the network node of a precoder in the set of precoders that the UE should use to transmit a physical channel such as, e.g., a PUSCH (step 1501). The UE determines the precoder (referred to here as a “first precoder”) from the indication.

The UE transmits N layers of the physical channel on one or more antenna port subsets of the set of 8 ports according to the (e.g., selected) first precoder of the set of precoders for N layers (step 1502). In other words, the UE transmits N layers of the physical channel on one or more antenna port subsets from among all antenna port subsets of the set of eight antenna ports. In one embodiment, the set of all antenna port subsets is {0,4}, {1,5}, {2,6}, and {3,7}, where the eight antenna ports are indexed from 0 to 7. In one embodiment, precoders in the set of precoders are NC precoders that maximize cross-polarized (‘xpol’) ports per group. For each NC precoder, each port in an xpol pair is transmitted for all xpol pairs for an even number of layers, and all but one xpol pair for an odd number of layers, where each port in an xpol pair is on a different layer. A given layer in each precoder of the set of precoders is transmitted on no more than 4 of the 8 antenna ports to avoid redundant precoders. In one embodiment, any one or more of the following (and in a preferred embodiment all of the following) are true:
N is at least two and is no more than 8,
each antenna port subset comprises two antenna ports,
   In other words, each antenna port subset from among the set of all antenna port subsets comprises two antenna ports. For example, each antenna port subset is a different xpol antenna port pair.
each antenna port is present in only one antenna port subset,
there is at most one antenna port subset with one active antenna port, and the remaining subsets have either no active antenna ports or two active antenna ports.
   In other words, for each precoder in the set of NC precoders for N layers, there is at most one of the antenna port subsets with one active antenna port for the precoder and all remaining antenna port subsets have either no active antenna ports for the precoder or two active antenna ports for the precoder.
each antenna port is transmitted on one and only one layer when the first precoder is used,
   In other words, for each precoder in the set of NC precoders for N layers, each antenna port of the set of eight antenna ports is active on at most one layer for the precoder; and
a same layer in each precoder of the set of precoders is transmitted on no more than 4 of the 8 antenna ports,
   In other words, for each layer of the N layers across the set of NC precoders for N layers, no more than four of the eight antenna ports are active for the layer across the set of precoders for N layers.

In one embodiment, the set of precoders (i.e., the codebook) targets both N_{g}=2 and 4 with a mix of precoders for a given number of layers. For ranks 3 and 4, N_{g}=2 case has one of either {0,1} or {2,3} ports active for the first polarization, while N_{g}=4 has {0,1}, {0,2}, {0,3}, {1,2}, {1,3} or {2,3} ports active. In one embodiment:
for the first precoder of the set of precoders for N layers, transmission is on at least
   a combination {p₁, p₂} of a first antenna port p₁ of a first antenna port subset of the antenna port subsets and a first antenna port p₂ of a second antenna port subset of the antenna port subsets with {p₁, p₂}={0,1}, or {2,3}
for a second precoder of the set of precoders for N layers, transmission is on at least
   a combination {p₃, p₄} of a first antenna port p₃ of a first antenna port subset of the antenna port subsets and a first antenna port p₄ of a second antenna port subset of the antenna port subsets with {p₃, p₄}={0,1}, {0,2}, {0,3}, {1,2}, {1,3} or {2,3}.

In one embodiment, the set of precoders (i.e., the codebook) has, for N_{g}=1, a mix of precoders for a given number of layers, where for rank 2, 3 and 4,

$$⌈ \frac{N}{2} ⌉ ,$$

N∈{2,3,4}, ports from {0,1,2,3} are active for the first polarization such that the difference between any two active port numbers is pⱼ−pᵢ>1, j>i. In one embodiment:
For the first precoder of the set of precoders for N layers, transmission is on at least a first antenna port p₁ of a first antenna port subset of the antenna port subsets and a first antenna port p₂ of a second antenna port subset of the antenna port subsets with {p₁, p₂}={0, 2}, {0, 3} or {1, 3}, and
when at least 3 layers are transmitted, a different antenna port p′₁ of the first antenna port subset is additionally transmitted upon.

In one embodiment, the set of precoders (i.e., the codebook) has, for N_{g}={1,2,4}, a mix of precoders for a given number of layers, where for rank ∈{5,6},

$$⌈ \frac{N}{2} ⌉ ,$$

N>4, ports from {0,1,2,3} are active for the first polarization). In one embodiment, when N=5 or N=6 layers are transmitted:
For the first precoder of the set of precoders for N layers, transmission is on at least a first antenna port p₁ of a first antenna port subset of the antenna port subsets, a first antenna port p₂ of a second antenna port subset of the antenna port subsets, and a third antenna port p₃ of a third antenna port subset of the antenna port subsets with {p₁, p₂, p₃}={0,1,2}, {0,1,3}, {0,2,3}, or {1,2,3} and
a different antenna port p′₂ of the second antenna port subset is additionally transmitted upon.

FIG. 16 is a flow chart that illustrates the operation of a network node in accordance with at least some of the embodiments described herein. Optional steps are represented by dashed lines/boxes. The network node may be, for example, a Radio Access Network (RAN) node such as, e.g., a base station (e.g., a gNB) or a RAN node that implements some of the functionality of a base station (e.g., a gNB-Distributed Unit (DU)). As illustrated, the network node first transmits, to a UE, signaling that configures the UE with precoders in a codebook to be used for transmission (step 1600). The codebook contains at least one set of precoders for N layers for NC multi-antenna transmission on one or more antenna port subsets of a set of eight (8) antenna ports. The network node also transmits, to the UE, an indication (e.g., a TPMI, but not limited thereto) of a precoder in the set of precoders that the UE should use to transmit a physical channel such as, e.g., a PUSCH (step 1602). Note that the UE determines the precoder (referred to here as a “first precoder”) from the indication.

In one embodiment, precoders in the set of precoders are NC precoders that maximize cross-polarized (‘xpol’) ports per group. For each NC precoder, each port in an xpol pair is transmitted for all xpol pairs for an even number of layers, and all but one xpol pair for an odd number of layers, where each port in an xpol pair is on a different layer. A given layer in each precoder of the set of precoders is transmitted on no more than 4 of the 8 antenna ports to avoid redundant precoders. In one embodiment, any one or more of the following (and in a preferred embodiment all of the following) are true:
N is at least two and is no more than 8,
each antenna port subset comprises two antenna ports,
each antenna port is present in only one antenna port subset,
there is at most one antenna port subset with one active antenna port, and the remaining subsets have either no active antenna ports or two active antenna ports.
each antenna port is transmitted on one and only one layer when the first precoder is used, and
a same layer in each precoder of the set of precoders is transmitted on no more than 4 of the 8 antenna ports.

In one embodiment, the set of precoders (i.e., the codebook) targets both N_{g}=2 and 4 with a mix of precoders for a given number of layers. For ranks 3 and 4, N_{g}=2 case has one of either {0,1} or {2,3} ports active for the first polarization, while N_{g}=4 has {0,1}, {0,2}, {0,3}, {1,2}, {1,3} or {2,3} ports active. In one embodiment:
for the first precoder of the set of precoders for N layers, transmission is on at least
   a combination {p₁, p₂} of a first antenna port p₁ of a first antenna port subset of the antenna port subsets and a first antenna port p₂ of a second antenna port subset of the antenna port subsets with {p₁, p₂}={0,1}, or {2,3}
for a second precoder of the set of precoders for N layers, transmission is on at least
   a combination {p₃, p₄} of a first antenna port p₃ of a first antenna port subset of the antenna port subsets and a first antenna port p₄ of a second antenna port subset of the antenna port subsets with {p₃, p₄}={0,1}, {0,2}, {0,3}, {1,2}, {1,3} or {2,3}.

In one embodiment, the set of precoders (i.e., the codebook) has, for N_{g}=1, a mix of precoders for a given number of layers, where for rank 2, 3 and 4,

$$⌈ \frac{N}{2} ⌉ ,$$

N∈{2,3,4}, ports from {0,1,2,3} are active for the first polarization such that the difference between any two active port numbers is pⱼ−pᵢ>1, j>i. In one embodiment:
For the first precoder of the set of precoders for N layers, transmission is on at least a first antenna port p₁ of a first antenna port subset of the antenna port subsets and a first antenna port p₂ of a second antenna port subset of the antenna port subsets with {p₁, p₂}={0, 2}, {0, 3} or {1, 3}, and
when at least 3 layers are transmitted, a different antenna port p′₁ of the first antenna port subset is additionally transmitted upon.

In one embodiment, the set of precoders (i.e., the codebook) has, for N_{g}={1,2,4}, a mix of precoders for a given number of layers, where for rank ∈{5,6},

$$⌈ \frac{N}{2} ⌉ ,$$

N>4, ports from {0,1,2,3} are active for the first polarization). In one embodiment, when N=5 or N=6 layers are transmitted:
For the first precoder of the set of precoders for N layers, transmission is on at least a first antenna port p₁ of a first antenna port subset of the antenna port subsets, a first antenna port p₂ of a second antenna port subset of the antenna port subsets, and a third antenna port p₃ of a third antenna port subset of the antenna port subsets with {p₁, p₂, p₃}={0,1,2}, {0,1,3}, {0,2,3}, or {1,2,3} and
a different antenna port p′₂ of the second antenna port subset is additionally transmitted upon.

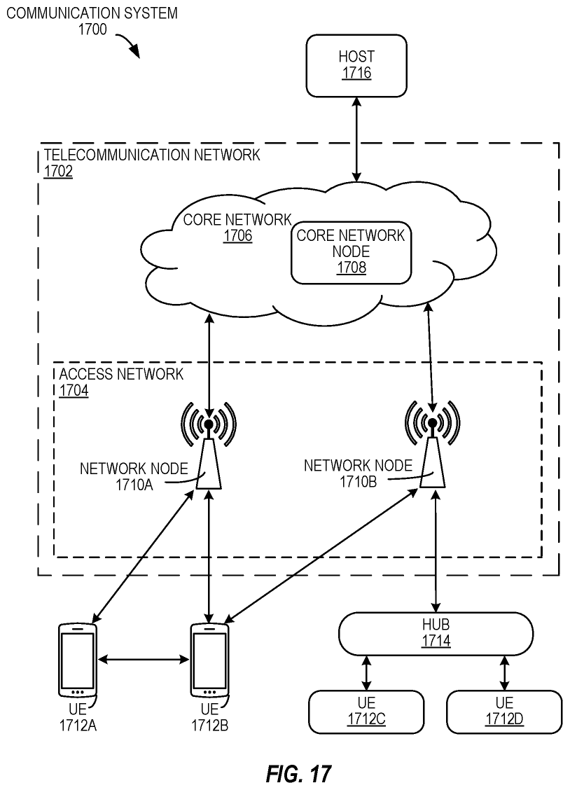

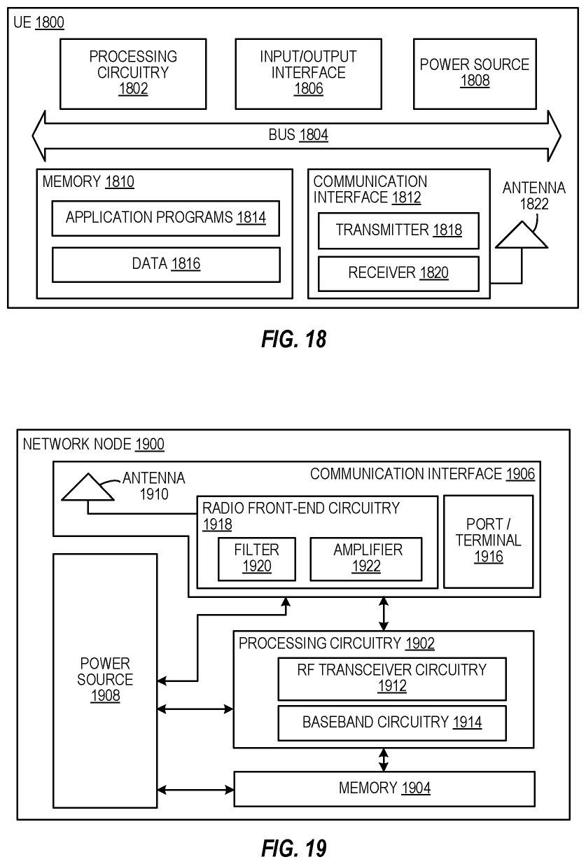

FIG. 17 shows an example of a communication system 1700 in accordance with some embodiments.

In the example, the communication system 1700 includes a telecommunication network 1702 that includes an access network 1704, such as a RAN, and a core network 1706, which includes one or more core network nodes 1708. The access network 1704 includes one or more access network nodes, such as network nodes 1710A and 1710B (one or more of which may be generally referred to as network nodes 1710), or any other similar 3GPP access nodes or non-3GPP Access Points (APs). Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 1702 includes one or more Open-RAN (ORAN) network nodes. An ORAN network node is a node in the telecommunication network 1702 that supports an ORAN specification (e.g., a specification published by the O-RAN Alliance, or any similar organization) and may operate alone or together with other nodes to implement one or more functionalities of any node in the telecommunication network 1702, including one or more network nodes 1710 and/or core network nodes 1708.

Examples of an ORAN network node include an Open Radio Unit (O-RU), an Open Distributed Unit (O-DU), an Open Central Unit (O-CU), including an O-CU Control Plane (O-CU-CP) or an O-CU User Plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 1710 facilitate direct or indirect connection of User Equipment (UE), such as by connecting UEs 1712A, 1712B, 1712C, and 1712D (one or more of which may be generally referred to as UEs 1712) to the core network 1706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1700 may include any number of wired or wireless networks, network nodes, UEs, and/or any other components or systems that may facilitate or participate in the communication of data and/or signals whether via wired or wireless connections. The communication system 1700 may include and/or interface with any type of communication, telecommunication, data, cellular, radio network, and/or other similar type of system.

The UEs 1712 may be any of a wide variety of communication devices, including wireless devices arranged, configured, and/or operable to communicate wirelessly with the network nodes 1710 and other communication devices. Similarly, the network nodes 1710 are arranged, capable, configured, and/or operable to communicate directly or indirectly with the UEs 1712 and/or with other network nodes or equipment in the telecommunication network 1702 to enable and/or provide network access, such as wireless network access, and/or to perform other functions, such as administration in the telecommunication network 1702.

In the depicted example, the core network 1706 connects the network nodes 1710 to one or more hosts, such as host 1716. These connections may be direct or indirect via one or more intermediary networks or devices. In other examples, network nodes may be directly coupled to hosts. The core network 1706 includes one more core network nodes (e.g., core network node 1708) that are structured with hardware and software components. Features of these components may be substantially similar to those described with respect to the UEs, network nodes, and/or hosts, such that the descriptions thereof are generally applicable to the corresponding components of the core network node 1708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 1716 may be under the ownership or control of a service provider other than an operator or provider of the access network 1704 and/or the telecommunication network 1702, and may be operated by the service provider or on behalf of the service provider. The host 1716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1700 of FIG. 17 enables connectivity between the UEs, network nodes, and hosts. In that sense, the communication system 1700 may be configured to operate according to predefined rules or procedures, such as specific standards that include, but are not limited to: Global System for Mobile Communications (GSM); Universal Mobile Telecommunications System (UMTS); LTE, and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 1702 is a cellular network that implements 3GPP standardized features. Accordingly, the telecommunication network 1702 may support network slicing to provide different logical networks to different devices that are connected to the telecommunication network 1702. For example, the telecommunication network 1702 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 1712 may be designed to transmit information to the access network 1704 on a predetermined schedule, when triggered by an internal or external event, or in response to requests from the access network 1704. Additionally, a UE may be configured for operating in single- or multi-Radio Access Technology (RAT) or multi-standard mode. For example, a UE may operate with any one or combination of WiFi, NR), and LTE, i.e. being configured for Multi-Radio Dual Connectivity (MR-DC), such as Evolved UMTS Terrestrial RAN (E-UTRAN) NR-Dual Connectivity (EN-DC).

In the example, a hub 1714 communicates with the access network 1704 to facilitate indirect communication between one or more UEs (e.g., UE 1712C and/or 1712D) and network nodes (e.g., network node 1710B). In some examples, the hub 1714 may be a controller, router, content source and analytics, or any of the other communication devices described herein regarding UEs. For example, the hub 1714 may be a broadband router enabling access to the core network 1706 for the UEs. As another example, the hub 1714 may be a controller that sends commands or instructions to one or more actuators in the UEs. Commands or instructions may be received from the UEs, network nodes 1710, or by executable code, script, process, or other instructions in the hub 1714. As another example, the hub 1714 may be a data collector that acts as temporary storage for UE data and, in some embodiments, may perform analysis or other processing of the data. As another example, the hub 1714 may be a content source. In still another example, the hub 1714 acts as a proxy server or orchestrator for the UEs, in particular if one or more of the UEs are low energy IoT devices.

The hub 1714 may have a constant/persistent or intermittent connection to the network node 1710B. The hub 1714 may also allow for a different communication scheme and/or schedule between the hub 1714 and UEs (e.g., UE 1712C and/or 1712D), and between the hub 1714 and the core network 1706. In other examples, the hub 1714 is connected to the core network 1706 and/or one or more UEs via a wired connection. Moreover, the hub 1714 may be configured to connect to a Machine-to-Machine (M2M) service provider over the access network 1704 and/or to another UE over a direct connection. In some scenarios, UEs may establish a wireless connection with the network nodes 1710 while still connected via the hub 1714 via a wired or wireless connection. In some embodiments, the hub 1714 may be a dedicated hub—that is, a hub whose primary function is to route communications to/from the UEs from/to the network node 1710B. In other embodiments, the hub 1714 may be a non-dedicated hub—that is, a device which is capable of operating to route communications between the UEs and the network node 1710B, but which is additionally capable of operating as a communication start and/or end point for certain data channels.

Note that the functionality of the UE described above, e.g., with respect to FIG. 15 may be performed by any one or more of the UEs 1712 of FIG. 17. Likewise, the functionality of the network node described above, e.g., with respect to FIG. 15 may be performed by any one or more of the network nodes 1710 of FIG. 17.

FIG. 18 shows a UE 1800 in accordance with some embodiments. Note that the UE 1800 is one example of a UE that may performed the functions described above, e.g., with respect to FIG. 15. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device.

The UE 1800 includes processing circuitry 1802 that is operatively coupled via a bus 1804 to an input/output interface 1806, a power source 1808, memory 1810, a communication interface 1812, and/or any other component, or any combination thereof. Certain UEs may utilize all or a subset of the components shown in FIG. 18. The level of integration between the components may vary from one UE to another UE. Further, certain UEs may contain multiple instances of a component, such as multiple processors, memories, transceivers, transmitters, receivers, etc.

The processing circuitry 1802 is configured to process instructions and data and may be configured to implement any sequential state machine operative to execute instructions stored as machine-readable computer programs in the memory 1810. The processing circuitry 1802 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 1802 may include multiple Central Processing Units (CPUs).

In the example, the input/output interface 1806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1800. Examples of an input device include a touch-sensitive or presence-sensitive display, a camera (e.g., a digital camera, a digital video camera, a web camera, etc.), a microphone, a sensor, a mouse, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1808 is structured as a battery or battery pack. Other types of power sources, such as an external power source (e.g., an electricity outlet), photovoltaic device, or power cell, may be used. The power source 1808 may further include power circuitry for delivering power from the power source 1808 itself, and/or an external power source, to the various parts of the UE 1800 via input circuitry or an interface such as an electrical power cable. Delivering power may be, for example, for charging of the power source 1808. Power circuitry may perform any formatting, converting, or other modification to the power from the power source 1808 to make the power suitable for the respective components of the UE 1800 to which power is supplied.

The memory 1810 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 1810 includes one or more application programs 1814, such as an operating system, web browser application, a widget, gadget engine, or other application, and corresponding data 1816. The memory 1810 may store, for use by the UE 1800, any of a variety of various operating systems or combinations of operating systems.

The memory 1810 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 1810 may allow the UE 1800 to access instructions, application programs, and the like stored on transitory or non-transitory memory media, to off-load data, or to upload data. An article of manufacture, such as one utilizing a communication system, may be tangibly embodied as or in the memory 1810, which may be or comprise a device-readable storage medium.

The processing circuitry 1802 may be configured to communicate with an access network or other network using the communication interface 1812. The communication interface 1812 may comprise one or more communication subsystems and may include or be communicatively coupled to an antenna 1822. The communication interface 1812 may include one or more transceivers used to communicate, such as by communicating with one or more remote transceivers of another device capable of wireless communication (e.g., another UE or a network node in an access network). Each transceiver may include a transmitter 1818 and/or a receiver 1820 appropriate to provide network communications (e.g., optical, electrical, frequency allocations, and so forth). Moreover, the transmitter 1818 and receiver 1820 may be coupled to one or more antennas (e.g., the antenna 1822) and may share circuit components, software, or firmware, or alternatively be implemented separately.

In the illustrated embodiment, communication functions of the communication interface 1812 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 1812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1800 shown in FIG. 18.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 19 shows a network node 1900 in accordance with some embodiments. Note that the network node 1900 is one example of a network node that may performed the functions described above, e.g., with respect to FIG. 16. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), NR Node Bs (gNBs)), and O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node), and/or Remote Radio Units (RRUs), sometimes referred to as Remote Radio Heads (RRHs). Such RRUs may or may not be integrated with an antenna as an antenna integrated radio. Parts of a distributed radio base station may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1900 includes processing circuitry 1902, memory 1904, a communication interface 1906, and a power source 1908. The network node 1900 may be composed of multiple physically separate components (e.g., a NodeB component and an RNC component, or a BTS component and a BSC component, etc.), which may each have their own respective components. In certain scenarios in which the network node 1900 comprises multiple separate components (e.g., BTS and BSC components), one or more of the separate components may be shared among several network nodes. For example, a single RNC may control multiple NodeBs. In such a scenario, each unique NodeB and RNC pair may in some instances be considered a single separate network node. In some embodiments, the network node 1900 may be configured to support multiple RATs. In such embodiments, some components may be duplicated (e.g., separate memory 1904 for different RATs) and some components may be reused (e.g., a same antenna 1910 may be shared by different RATs). The network node 1900 may also include multiple sets of the various illustrated components for different wireless technologies integrated into network node 1900, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1900.

The processing circuitry 1902 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1900 components, such as the memory 1904, to provide network node 1900 functionality.

In some embodiments, the processing circuitry 1902 includes a System on a Chip (SOC). In some embodiments, the processing circuitry 1902 includes one or more of Radio Frequency (RF) transceiver circuitry 1912 and baseband processing circuitry 1914. In some embodiments, the RF transceiver circuitry 1912 and the baseband processing circuitry 1914 may be on separate chips (or sets of chips), boards, or units, such as radio units and digital units. In alternative embodiments, part or all of the RF transceiver circuitry 1912 and the baseband processing circuitry 1914 may be on the same chip or set of chips, boards, or units.

The memory 1904 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1902. The memory 1904 may store any suitable instructions, data, or information, including a computer program, software, an application including one or more of logic, rules, code, tables, and/or other instructions capable of being executed by the processing circuitry 1902 and utilized by the network node 1900. The memory 1904 may be used to store any calculations made by the processing circuitry 1902 and/or any data received via the communication interface 1906. In some embodiments, the processing circuitry 1902 and the memory 1904 are integrated.

The communication interface 1906 is used in wired or wireless communication of signaling and/or data between a network node, access network, and/or UE. As illustrated, the communication interface 1906 comprises port(s)/terminal(s) 1916 to send and receive data, for example to and from a network over a wired connection. The communication interface 1906 also includes radio front-end circuitry 1918 that may be coupled to, or in certain embodiments a part of, the antenna 1910. The radio front-end circuitry 1918 comprises filters 1920 and amplifiers 1922. The radio front-end circuitry 1918 may be connected to the antenna 1910 and the processing circuitry 1902. The radio front-end circuitry 1918 may be configured to condition signals communicated between the antenna 1910 and the processing circuitry 1902. The radio front-end circuitry 1918 may receive digital data that is to be sent out to other network nodes or UEs via a wireless connection. The radio front-end circuitry 1918 may convert the digital data into a radio signal having the appropriate channel and bandwidth parameters using a combination of the filters 1920 and/or the amplifiers 1922. The radio signal may then be transmitted via the antenna 1910. Similarly, when receiving data, the antenna 1910 may collect radio signals which are then converted into digital data by the radio front-end circuitry 1918. The digital data may be passed to the processing circuitry 1902. In other embodiments, the communication interface 1906 may comprise different components and/or different combinations of components.

In certain alternative embodiments, the network node 1900 does not include separate radio front-end circuitry 1918; instead, the processing circuitry 1902 includes radio front-end circuitry and is connected to the antenna 1910. Similarly, in some embodiments, all or some of the RF transceiver circuitry 1912 is part of the communication interface 1906. In still other embodiments, the communication interface 1906 includes the one or more ports or terminals 1916, the radio front-end circuitry 1918, and the RF transceiver circuitry 1912 as part of a radio unit (not shown), and the communication interface 1906 communicates with the baseband processing circuitry 1914, which is part of a digital unit (not shown).

The antenna 1910 may include one or more antennas, or antenna arrays, configured to send and/or receive wireless signals. The antenna 1910 may be coupled to the radio front-end circuitry 1918 and may be any type of antenna capable of transmitting and receiving data and/or signals wirelessly. In certain embodiments, the antenna 1910 is separate from the network node 1900 and connectable to the network node 1900 through an interface or port.

The antenna 1910, the communication interface 1906, and/or the processing circuitry 1902 may be configured to perform any receiving operations and/or certain obtaining operations described herein as being performed by the network node 1900. Any information, data, and/or signals may be received from a UE, another network node, and/or any other network equipment. Similarly, the antenna 1910, the communication interface 1906, and/or the processing circuitry 1902 may be configured to perform any transmitting operations described herein as being performed by the network node 1900. Any information, data, and/or signals may be transmitted to a UE, another network node, and/or any other network equipment.

The power source 1908 provides power to the various components of the network node 1900 in a form suitable for the respective components (e.g., at a voltage and current level needed for each respective component). The power source 1908 may further comprise, or be coupled to, power management circuitry to supply the components of the network node 1900 with power for performing the functionality described herein. For example, the network node 1900 may be connectable to an external power source (e.g., the power grid or an electricity outlet) via input circuitry or an interface such as an electrical cable, whereby the external power source supplies power to power circuitry of the power source 1908. As a further example, the power source 1908 may comprise a source of power in the form of a battery or battery pack which is connected to, or integrated in, power circuitry. The battery may provide backup power should the external power source fail.

Embodiments of the network node 1900 may include additional components beyond those shown in FIG. 19 for providing certain aspects of the network node's functionality, including any of the functionality described herein and/or any functionality necessary to support the subject matter described herein. For example, the network node 1900 may include user interface equipment to allow input of information into the network node 1900 and to allow output of information from the network node 1900. This may allow a user to perform diagnostic, maintenance, repair, and other administrative functions for the network node 1900.

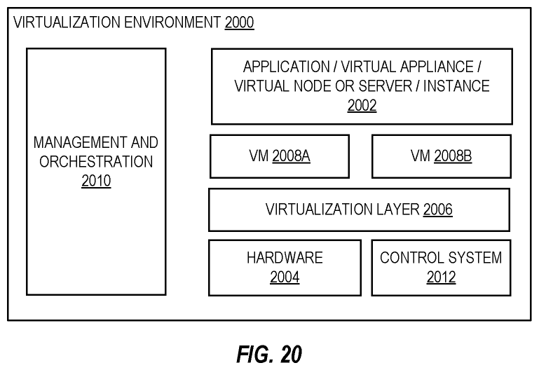

FIG. 20 is a block diagram illustrating a virtualization environment 2000 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 2000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 2000 includes components defined by the O-RAN Alliance, such as an O-Cloud environment orchestrated by a Service Management and Orchestration Framework via an O-2 interface.

Applications 2002 (which may alternatively be called software instances, virtual appliances, network functions, virtual nodes, virtual network functions, etc.) are run in the virtualization environment 2000 to implement some of the features, functions, and/or benefits of some of the embodiments disclosed herein.

Hardware 2004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2006 (also referred to as hypervisors or VM Monitors (VMMs)), provide VMs 2008A and 2008B (one or more of which may be generally referred to as VMs 2008), and/or perform any of the functions, features, and/or benefits described in relation with some embodiments described herein. The virtualization layer 2006 may present a virtual operating platform that appears like networking hardware to the VMs 2008.

The VMs 2008 comprise virtual processing, virtual memory, virtual networking, or interface and virtual storage, and may be run by a corresponding virtualization layer 2006. Different embodiments of the instance of a virtual appliance 2002 may be implemented on one or more of the VMs 2008, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 2008 may be a software implementation of a physical machine that runs programs as if they were executing on a physical, non-virtualized machine. Each of the VMs 2008, and that part of the hardware 2004 that executes that VM, be it hardware dedicated to that VM and/or hardware shared by that VM with others of the VMs 2008, forms separate virtual network elements. Still in the context of NFV, a virtual network function is responsible for handling specific network functions that run in one or more VMs 2008 on top of the hardware 2004 and corresponds to the application 2002.

The hardware 2004 may be implemented in a standalone network node with generic or specific components. The hardware 2004 may implement some functions via virtualization. Alternatively, the hardware 2004 may be part of a larger cluster of hardware (e.g., such as in a data center or CPE) where many hardware nodes work together and are managed via management and orchestration 2010, which, among others, oversees lifecycle management of the applications 2002. In some embodiments, the hardware 2004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a base station. In some embodiments, some signaling can be provided with the use of a control system 2012 which may alternatively be used for communication between hardware nodes and radio units.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Those skilled in the art will recognize improvements and modifications to the embodiments of the present disclosure. All such improvements and modifications are considered within the scope of the concepts disclosed herein.

1. A method performed by a User Equipment (UE), for non-coherent (NC) multi-antenna transmission, the method comprising:
transmitting N layers on one or more antenna port subsets from a plurality of antenna port subsets of a set of eight antenna ports according to at least one precoder of a set of NC precoders for N layers, wherein:
N is at least two and is no more than eight,
each antenna port subset of the plurality of antenna port subsets comprises two antenna ports from the set of eight antenna ports,
each antenna port of the set of eight antenna ports is present in only one of the plurality of antenna port subsets, and
any one or more of the following:
for each precoder in the set of NC precoders for N layers, there is at most one of the plurality of antenna port subsets with one active antenna port for the precoder, and all remaining antenna port subsets of the plurality of antenna port subsets have either no active antenna ports for the precoder or two active antenna ports for the precoder,
for each precoder in the set of NC precoders for N layers, each antenna port of the set of eight antenna ports is active on at most one layer for the precoder,
for each layer of the N layers across the set of NC precoders for N layers, no more than four of the set of eight antenna ports are active for the layer across the set of precoders for N layers.

2. The method of claim 1, wherein the set of precoders for N layers comprises a precoder for N layers comprising a combination {p₁, p₂} of active antenna ports for a first layer of the N layers and a second layer of the N layers, the combination {p₁, p₂} of active antenna ports consisting of a first antenna port p₁ of a first antenna port subset of the plurality of antenna port subsets and a first antenna port p₂ of a second antenna port subset of the plurality of antenna port subsets.

3. The method of claim 2, wherein {p₁, p₂}={0,1} or {2,3} or {p₁, p₂}={0,1}, {0,2}, {0,3}, {1,2}{1,3} or {2,3}, where the set of eight antenna ports are indexed from 0 to 7, and the plurality of subsets of the set of eight antenna ports consist of antenna port subsets {0,4}, {1,5}, {2,6}, and {3,7}.

4. (canceled)

5. The method of claim 2, wherein the set of precoders for N layers further comprises a second precoder for N layers wherein for the second precoder {p₁, p₂}={0,1}, {0,2}, {0,3}, {1,2}, {1,3} or {2,3}, wherein the set of eight antenna ports are indexed from 0 to 7, and the plurality of subsets of the set of eight antenna ports consist of antenna port subsets {0,4}, {1,5}, {2,6}, and {3,7}.

6. The method of claim 2, wherein N=3, and the precoder for N layers further comprises an active antenna port p₃ for a third layer of the N layers wherein the active antenna port p₃ for the third layer is a second antenna port of the first antenna port subset or a second antenna port of the second antenna port subset.

7. The method of claim 6, wherein {p₁, p₂, p₃}={0,1,4} or {2,3,6} or {p₁, p₂, p₃}={0,1,4}, {0,2,4}, {0,3,4}, {1,2,5}, {1,3,5} or {2,3,6}, where the set of eight antenna ports are indexed from 0 to 7, the plurality of subsets of the set of eight antenna ports consist of antenna port subsets {0,4}, {1,5}, {2,6}, and {3,7}.

8. (canceled)

9. The method of claim 2, wherein N≥4, and the precoder for N layers further comprises a second combination {p₃, p₄} of active antenna ports for a third layer of the N layers and a fourth layer of the N layers, the second combination {p₃, p₄} of active antenna ports consisting of a second antenna port p₃ of the first antenna port subset and a second antenna port p₄ of the second antenna port subset.

10. The method of claim 9, wherein {p₁, p₂, p₃, p₄}={0,1,4,5} or {2,3,6,7} or {p₁, p₂, p₃, p₄}={0,1,4,5}, {0,2,4,6}, {0,3,4,2}, {1,2,5,6}, {1,3,5,7} or {2,3,6,7} or {p₁, p₂, p₃, p₄}={0,1,4,5}, {0,2,4,6}, {1,3,5,7} or {2,3,6,7}, where the set of eight antenna ports are indexed from 0 to 7, the plurality of subsets of the set of eight antenna ports consist of antenna port subsets {0,4}, {1,5}, {2,6}, and {3,7}.

11. (canceled)

12. (canceled)

13. The method of claim 1, wherein the set of precoders for N layers comprises a precoder for N layers comprising a combination {p₁, p₂} of active antenna ports for a first layer of the N layers and a second layer of the N layers, the combination {p₁, p₂} of active antenna ports consisting of a first antenna port p₁ of a first antenna port subset of the plurality of antenna port subsets and a first antenna port p₂ of a second antenna port subset of the plurality of antenna port subsets, wherein p₁ and p₂ are antenna port indices and have a difference between p₂-p₁>1.

14. The method of claim 13, wherein {p₁, p₂}={0, 2}, {0, 3} or {1, 3}, where the set of eight antenna ports are indexed from 0 to 7 and the plurality of subsets of the set of eight antenna ports consist of antenna port subsets {0,4}, {1,5}, {2,6}, and {3,7}.

15. The method of claim 13, wherein N≥3, and a different antenna port p′₁ of the first antenna port subset is active for a third layer of the N layers.

16. The method of claim 1, wherein:
N=5 or N=6;
the set of precoders for N layers comprises a precoder for N layers comprising a combination {p₁, p₂, p₃} of active antenna ports for a first layer of the N layers, a second layer of the N layers, and a third layer of the N layers, respectively; and
the combination {p₁, p₂, p₃} of active antenna ports consists of a first antenna port p₁ of a first antenna port subset of the plurality of antenna port subsets, a first antenna port p₂ of a second antenna port subset of the plurality of antenna port subsets, and a first antenna port p₃ of a third antenna port subset of the plurality of antenna port subsets.

17. The method of claim 16, wherein the precoder comprises a different antenna port p′₂ of the second antenna port subset that is active for another layer of the N layers.

18. The method of claim 16, wherein {p₁, p₂, p₃}={0,1,2}, {0,1,3}, {0,2,3}, or {1,2,3}, where the set of eight antenna ports are indexed from 0 to 7 and the plurality of subsets of the set of eight antenna ports consist of antenna port subsets {0,4}, {1,5}, {2,6}, and {3,7}.

19. The method of claim 18, wherein the precoder further comprises a second combination {p₄, p₅} of active antenna ports for a fourth layer of the N layers and a fifth layer of the N layers, respectively, and the combination {p₄, p₅} of active antenna ports consists of a second antenna port p₄ of the first antenna port subset and a second antenna port p₅ of either the second antenna port subset or the third antenna port subset.

20. The method of claim 19, wherein {p₁, p₂, p₃, p₄, p₅}={0,1,3,4,5}, {0,1,3,5,7}, {1,2,3,5,6}, or {1,2,3,6,7}, where the set of eight antenna ports are indexed from 0 to 7 and the plurality of subsets of the set of eight antenna ports consist of antenna port subsets {0,4}, {1,5}, {2,6}, and {3,7}.

21. (canceled)

22. (canceled)

23. The method of claim 1, further comprising receiving, from a network node, signaling that configures the UE with precoders in a codebook to be used for transmission, wherein the codebook comprises the set of NC precoders.

24. The method of claim 1, further comprising receiving, from a network node, an indication of the precoder to be used by the UE for the transmitting.

25. (canceled)

26. (canceled)

27. A User Equipment (UE) for non-coherent (NC) multi-antenna transmission, the UE comprising:
a communication interface comprising a transmitter and a receiver; and
processing circuitry associated with the communication interface, the processing circuitry configured to cause the UE to transmit N layers on one or more antenna port subsets from a plurality of antenna port subsets of a set of eight antenna ports according to at least one precoder of a set of NC precoders for N layers, wherein:
N is at least two and is no more than eight,
each antenna port subset of the plurality of antenna port subsets comprises two antenna ports from the set of eight antenna ports,
each antenna port of the set of eight antenna ports is present in only one of the plurality of antenna port subsets, and
any one or more of the following:
for each precoder in the set of NC precoders for N layers, there is at most one of the plurality of antenna port subsets with one active antenna port for the precoder, and all remaining antenna port subsets of the plurality of antenna port subsets have either no active antenna ports for the precoder or two active antenna ports for the precoder,
for each precoder in the set of NC precoders for N layers, each antenna port of the set of eight antenna ports is active on at most one layer for the precoder,
for each layer of the N layers across the set of NC precoders for N layers, no more than four of the set of eight antenna ports are active for the layer across the set of precoders for N layers.

28. (canceled)

29. A method performed by a network node comprising:
transmitting to a User Equipment (UE) an indication of a precoder to be used by the UE for transmission, the precoder being indicated from among codebook comprising a set of Non-Coherent (NC) precoders for non-coherent multi-antenna transmission using N layers on one or more antenna port subsets of a plurality of antenna port subsets of a set of eight antenna ports, wherein:
N is at least two and is no more than eight,
each antenna port subset of the plurality of antenna port subsets comprises two antenna ports from the set of eight antenna ports,
each antenna port of the set of eight antenna ports is present in only one of the plurality of antenna port subsets, and
any one or more of the following:
for each precoder in the set of NC precoders for N layers, there is at most one of the plurality of antenna port subsets with one active antenna port for the precoder, and all remaining antenna port subsets of the plurality of antenna port subsets have either no active antenna ports for the precoder or two active antenna ports for the precoder,
for each precoder in the set of NC precoders for N layers, each antenna port of the set of eight antenna ports is active on at most one layer for the precoder,
for each layer of the N layers across the set of NC precoders for N layers, no more than four of the set of eight antenna ports are active for the layer across the set of precoders for N layers.

30-53. (canceled)
